(19) United States
(12) Patent Application Publication
(10) Pub. No.: US 2001/0002753 A1
(43) Pub. Date: Jun. 7, 2001

(54) Multipart label, its production and use

(76) Inventors: Marc-Oliver Hollwarth-Oberholz, Waldsee (DE); Karin Boldt, Lampertheim (DE); Simone Fricke, Ludwigshafen (DE); Christiane Koop, Weisenheim (DE)

Correspondence Address: Messrs. Keil & Weinkauf, 1101 Connecticut Ave., N.W., Washington, DC, 20036, US

(21) Appl. No.: 09/726,040

(22) Filed: Nov. 30, 2000

(30) Foreign Application Priority Data
Dec. 2, 1999 (DE) 19958093.6

(51) Int. Cl. B42D 15/00

(52) U.S. Cl. 283/81

(57) ABSTRACT

A description is given of a multi-ply label for applying information to primary or secondary packages, having a marking area which is enlarged with respect to the package areas, comprising a flat base element which is suitable for fixing the label on the package to be labeled, or which is itself part of the package, one or more flat information carriers, which are fixed to the base element such that they can be folded, and a hold-closed means which can be activated and deactivated and which prevents the label being folded out or turned over unintentionally and, if necessary, components which permit the security closure of the package.

In addition, methods of producing the label and using the label are described.

The present invention relates to a multi-ply label for applying information to primary or secondary packages, having a marking area which is enlarged with respect to the package areas, comprising a flat base element which is suitable for fixing the label on the package to be labeled, or which is itself part of the package, one or more flat information carriers, which are fixed to the base element such that they can be folded, and a hold-closed means which can be activated and deactivated and which prevents the label being folded out or turned over unintentionally and, if necessary, components which permit the security closure of the package.

For the distribution of relatively small quantities of small parts, these have for a long time and to an increasing extent been packed in small packs. The advantage of this measure is to provide the consumer with an easily comprehensible supply of the material and, at the same time, to facilitate the sales operation itself, for example by the possibility for self-service. Thus, for example, screws or nails, sorted by size and design, are marketed in small packs. Small technical subassemblies, such as small transformers, operational amplifiers, printer cartridges or small internal combustion engines for model aircraft, are likewise offered on the market packed in small packs for secure transport and sales. In general, it can be stated that all objects and materials which are intended to reach a user or consumer securely protected in relatively small quantities are expediently packed in small packs.

This applies to a particular extent to materials which are provided for the medical treatment of humans and animals, or are intended to be used for scientific purposes and/or have to be handled with particular care. Medicines and, for example, clinical test drugs must therefore necessarily reach the user or consumer in a secure package, which is matched to the type of product packed.

A problem arises then when information about the pack content is to be given or must be given to the consumer or user. In particular in the case of medicines and test drugs, there is the necessity of forwarding comprehensive, detailed information about the characteristics, handling and precautionary measures which may need to be taken when using the content of the pack to the user or consumer. Often, in particular in the case of drugs and test preparations, there are statutory regulations about the scope of the information to be provided, and these differ to some extent from country to country, so that in the case of global business activities the necessity arises to forward country-specific information in the respective national languages to consumers and users.

Thus, for example, the labeling of clinical test samples with data relevant to a study is becoming increasingly different, on the basis of EU GMP recommendations and directives and national requirements and are nonetheless intended to meet the highest degree of flexibility with respect to the use of the medication in as many countries as possible.

Hitherto, primary and secondary packaging material, in particular, could be identified only on the package areas themselves, which was naturally limited by the size of the package. The application of information, in particular the many and various mandatory instructions and safety and handling information by means of labeling, printing, embossing, stamping, burning in or other methods was therefore greatly impaired or became impossible to the required extent. Although the quantity of information to be applied can be increased to a certain extent by reducing the text size, this is at the cost of legibility and clarity.

Of course, the necessary information could be imparted to the user or consumer by in-pack leaflets, but this type of forwarding information does not meet the provisions of the AMG [German drugs legislation], according to which, in particular for clinical test preparations, a permanent application of the information and identification on the packaging material itself is prescribed.

Approaches are already known to configure packages in such a way that they can carry more content-related information than that for which there is space on their surface. EP-A-833295 discloses a label for containers in which a number of folded information sheets are enclosed between a bottom sheet adhesively bonded to the container and a top sheet fitted over said bottom sheet. At its two ends, the top sheet is fastened to the container by means of adhesive areas in such a way that one of the adhesive areas is a contact-adhesive area, which can be opened and closed again. After the contact-adhesive area has been opened, the information sheets can be removed. After the information has been looked at, the information sheets can be inserted between the bottom sheet and top sheet again, and the top sheet can be closed at the contact-adhesive area. A significant drawback with this label is that the information sheets can be separated from the container, can be lost and interchanged. In a further known embodiment of this label, the information sheets can be bonded in between the bottom and the top sheet. A drawback with these labels is that a non-adhesive smooth area additionally has to be applied to the packaging at a defined distance from the label, which entails additional production costs.

CA-A-2216094 discloses a device which permits information about medicines to be given to specific persons and for a specific purpose. The device, which can be fixed to the medicine pack, comprises a number of information sheets, which are joined to one another at their edges via contact-adhesive areas so that they can be separated, to form a strip and are then combined in a zigzag shape to form a stack. The individual information sheets are separated from the stack and distributed as intended. This device therefore does not represent a label for the secure, permanent identification of the content of the pack.

There has for a long time been an urgent requirement for a possibility of enlarging the identification area which is normally available on a package in a manner which is technically simple and cost-effective.

Furthermore, in particular in the medical area, there is the need to transfer information relating to the content or the coding of the content of containers to other objects, to provide it to specific groups of persons or to have it available for documentation purposes. In this case, sources of error are to be ruled out as far as possible.

In EP-B-0 463 193, in order to solve this problem, it is proposed, in order to identify a package, for example a cylindrical bottle, to use a strip-like self-adhesive label which is coated on the rear with an adhesive and whose length is greater than the circumference of the bottle, the overlapping part of the strip being formed as a portion which can be separated. On the front side, the label strip is provided with an adhesive-repelling smooth layer in the overlap area. If the label is stuck around the bottle, then the separable layer comes to lie on the smooth layer. It can therefore be pulled off the bottle, together with its rear contact-adhesive layer, and stuck onto a different object, for example an injection, which has been drawn out of the bottle.

The multipart label according to the invention which is described in the following sections meets these requirements. It can be produced in a technically simple and cost-effective manner, provides an information area which can be joined permanently to the package or is permanently joined to the package, which has a multiple of the area which is available on the package itself and therefore takes account both of EU guidelines and national stipulations. It therefore offers a reliable solution to the problem of transmitting easily legible information in a clear arrangement, with clear organization in terms of language, country and classification, to the user or consumer.

The possibility of expanding the space offered by the multi-ply label according to the invention as required, provides a flexible label concept, which takes account of all client-specific requirements and can therefore be used advantageously in a large number of business sectors, for example in trade, business and industry.

For example, the multi-ply labels according to the invention can be used with particular advantage in the pharmaceutical and chemical industry sector for packaging medical products, such as pellets, tablets, capsules, ampoules, vials and ready-prepared injections, or for the packaging of plant protection agents such as insecticidal strips, fertilizers in pellet or tablet form for simple and reliable dosing, in the cosmetics sector, for example for denture cleaning tablets, in the foodstuffs industry, for example for food supplements such as vitamin preparations and drink packs, in the metal industry, in tool and machine construction and in the vehicle industry for small and spare parts, in the domestic industry, for example for detergent and dishwasher tablets, and in all other sectors where, by means of the multi-ply label according to the invention, comprehensive, clear, captive, informative text is to be applied to primary or secondary packing material.

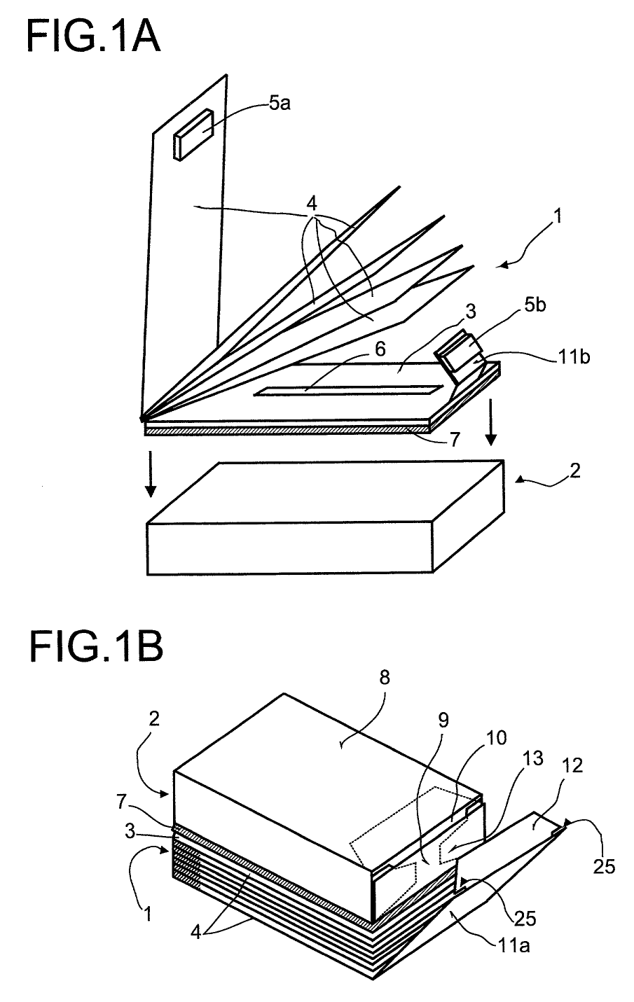

The present invention relates to the multipart label (1) which, for the purpose of illustration, is shown schematically and not to scale in an oblique plan view in FIGS. 1a and 1b, for applying information, in particular information relating to the content, to primary or secondary packaging (2) with a marking area which is enlarged with respect to the packaging areas, comprising a flat base element (3), which is suitable for fixing the label securely to the packaging to be labeled or is itself part of the packaging, one or more flat information carriers (4), which are fastened (hinged) to the base element (3) such that they can be folded, and a hold-closed means which can be activated and deactivated, comprising either

A) contact-adhesive elements which act between the uppermost or one of the upper information carriers and the base element or the lowest or one of the lower information carriers and can either be applied directly to the components of the label which are to be connected or to flap- or tongue-shaped extensions (hold-closed extensions), symbolized in Figure la by the adhesive element 5a applied to the uppermost information carrier at the adhesive element 5b which interacts with the former and is applied to the hold-closed extension 11b, or

B) an extension to the uppermost or one of the upper information carriers which, after the label has been fixed to the package, can interact with a functional constructional feature which is necessarily present in the package, is symbolized in FIG. 1b by the slot opening (10) present between the closing tongue and the outer of the package of a folding box and, in the active state, i.e. when the elements are united with force-fit and form-fit, prevents those parts of the label which are enclosed by the closure device, from folding out unintentionally.

In FIG. 1a, it is also possible to see the fields (6) which, if desired, may be present in preferred embodiments of the label according to the invention and on which label numbers and/or other indispensable information, for example about the pack content and/or safety instructions, can be indicated. Figure la also shows a fastening means, symbolized here by the adhesive coating (7), with which the base element can be fastened to the package (2). FIG. 1a also illustrates, by means of the arrows directed downward, the actions of placing the label (1) on the package (2) and fastening it.

FIG. 1b shows, in an oblique view, not to scale, a folding-box package (2) provided with a label (1) according to the invention and having a base element (3) and information carriers (4), with the outer (8) of the package and the closure flap (9), the parts of the closure flap which have been inserted under the outer of the package and are not visible being illustrated dashed, and an exaggerated illustration being used to show the functional slot opening (10) which is necessarily present in the package and into which the insertion end 12 of the hold-closed extension (11a) fitted to the uppermost information carrier can be inserted. The figure also shows, likewise in a dashed illustration, the trapezoidal box elements (13) which, before the closure flap is pushed in, are bent inward and which, if appropriate, interacting with non-obligatory lateral cuts on the closure flap and/or on the hold-closed extension (25), effect additional security against inadvertent opening of the package and/or the action of holding the label closed.

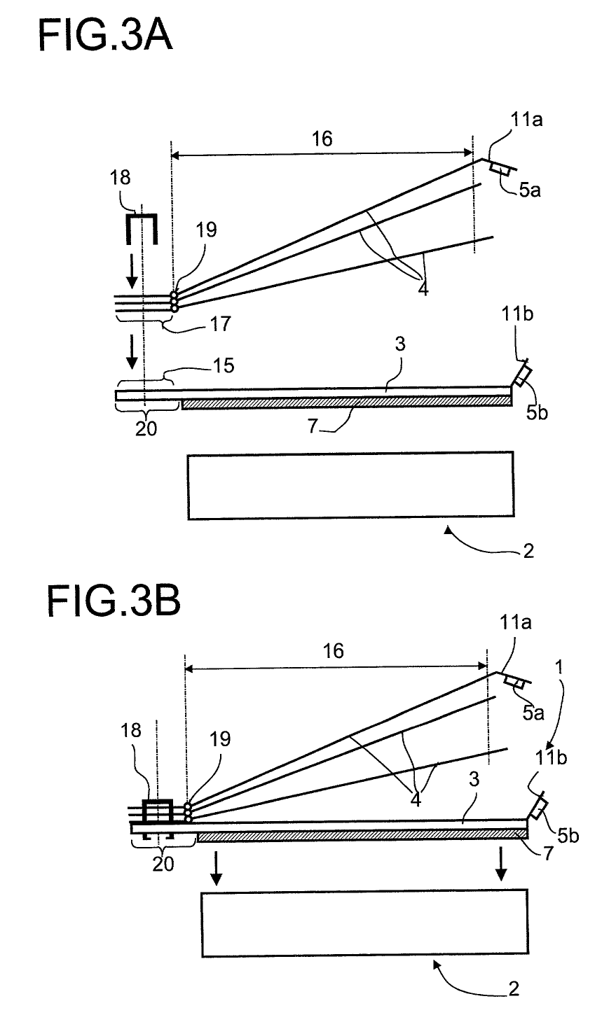

The base element is a blank made of one of the suitable flat materials described further below. The surface size and form of the base element depend on the dimensions of the areas which are available on the package and suitable for applying the label. If it is not desired for special reasons described further below for the base element to form an overhang on one or two edges of the package (cf. for example FIGS. 3a, 3b, 13a, 13b, 14 and 15, No. 20), it is preferably dimensioned such that it does not project beyond the area envisaged for the application, but ends flush with the edges of the package or covers only part of the area. Although the maximum adhesion force can be obtained when the label covers the entire area of the package, in particular the largest area, there may be special conditions under which partial coverage is adequate or preferred. For example, one area of the package can be adequately flat for fixing a base element only in some areas, or a subarea has to be left free since it must remain accessible for the purpose of removing the pack content.

However, in principle all means which are suitable for such a purpose are considered as the fastening means with which the base element can be fixed to the package area. The selection of this adhesive is carried out in accordance with the requirements of practice, for example the required strength of the adhesive connection, long-term stability, the acceptable manufacturing costs for the label and the handling possibilities for the user and the package configurations.

The adhesive can be applied to the adhesive side of the base element, or the fixing of the base element on the package can be carried out with separate, commercially available fastening means or using fastening means integrated in the package.

Separate, commercially available fastening means with which the base element can be fixed to the package in a manner known per se are, for example, staples, rivets or adhesives. Fastening means which are a constituent part of the package can have the form of grooves, into which a stiff base element can be inserted, they may be elastic anchors which engage in openings in the base element and snap in, or it can be an adhesive layer, for example a contact adhesive layer, applied to one area of the pack. Adhesive means which are a constituent part of the label according to the invention may conceivably be, for example, likewise elastic, hook-like anchors which snap into openings in the package, or a layer of adhesive.

The base element is preferably provided on the adhesive side, over part of the area or all of the area, with an adhesive layer which is suitable for the secure fixing of the label on the package to be labeled. Fixing the base element on the package with maximum strength is naturally the result if the adhesive area extends over the entire lower area of the base element.

The adhesives considered are those which develop their adhesive force only after a pretreatment, for example after moistening with a liquid, water or a solvent, or else those which readily adhere to an area (if necessary, appropriately pretreated) on the package. The adhesives considered are solvent-containing or else solvent-free adhesives. Adhesive layers which adhere immediately, referred to below as a contact-adhesive layer, are expediently covered with a peel-off protective film, in order to avoid inadvertent bonding of the label to instruments and other objects.

A further possibility for fixing the base element to an area of the packing results if this area and the base element consist of a thermoplastic material. In this case, the base element can be welded to the aforesaid area of the package over the entire area or at certain points.

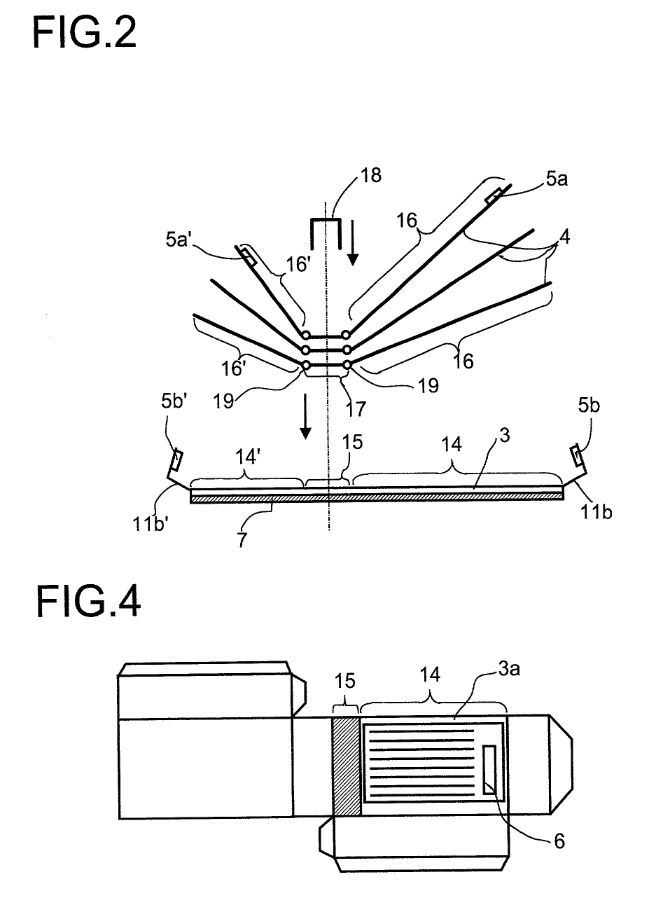

The information carriers can either be fastened at one edge of the base element, as illustrated in FIG. 1, or on a portion of the area of the base element provided for the purpose, the fastening area. In the case of the last-mentioned type of fastening, that side of the base element opposite the adhesive side is divided into one or, as shown in FIG. 2, two information areas (14, 14′) to accommodate information, and a fastening area (15) for fastening the information carrier.

FIG. 2 illustrates, in schematic form, in a side view in the form of an exploded illustration, a multi-part label according to the invention and having this construction. Located above the base element (3) with its information areas (14, 14′) and its fastening area (15) there is a group of three information carriers (4) which each have two information areas (16 and 16′) and a fastening area (17) located in between. Information carriers and base element are centered in relation to one another in such a way that when the information carriers are lowered, the fastening areas of the base element and of the information carriers come to rest on one another and can be fixed to one another in this position by the staples (18). The figure also shows, symbolized by the small circles (19), the flexibilized zones which may be arranged between the information area and fastening area and permit the information carriers to be folded open (turned over) simply, even if the information carriers do not consist of an adequately flexible material, such as paper, nonwoven or film. In addition, FIG. 2 shows the adhesive elements (5b) and (5b′) fitted to the hold-closed extensions (11b) and (11b′) as well as the conjugate adhesive elements (5a) and (5a′) interacting with the latter and fixed to the uppermost information carrier.

The fastening area (15) of the base element occupies a relatively narrow portion of the area of the base element, which is expediently located parallel to one edge, preferably a short edge, of the base element.

Said fastening area, as shown in FIG. 2, can in principle be located at any desired point on the base element area and is placed in accordance with practical points of view, in particular in accordance with the requirements of the user. For the majority of users, it is advantageous if the fastening area is located at one end of the base element.

As explained above, although it is often expedient for the size and shape of the base element to correspond to the size and shape of the package area to be labeled, it is occasionally more advantageous to deviate from this. For example, it may be advantageous if the base element projects beyond the area of the package to which it is to be fixed, at one or two edges, forming one or two overhang areas (20). Such an overhang—also referred to in the following description as a “base element overhang” or as a “base overhang”—can, as explained further below and illustrated, for example, in FIGS. 3a, 3b, 13a, 13b, 14 and 15, be advantageous for a particular configuration of the label according to the invention or for fixing the information carriers to the base element.

An overhang can be fastened subsequently to a base element cut to size suitably for the area of the package. It is preferable if it constitutes an extension of a base element which has been cut to size in such a way that only part of its area is used for fastening to the package. FIG. 3a illustrates, likewise in the manner of an exploded illustration, schematically in a side view and not to scale, a package (2) on which, by means of the adhesive layer (7), the base element (3) of the label according to the invention is placed and fixed, having an overhang (20) which reaches beyond the area of the package. The fastening area (15) of the base element rests on the overhang (20) here. In this embodiment, too, the illustrated size of the base element is not obligatory. It could quite possibly also be smaller than the area of the package, as long as its area is sufficient to apply the necessary information and to provide the label with a secure hold on the pack.

The information carriers (4) illustrated above the base element are positioned in such a way that, when they are lowered in the direction of the arrow, their fastening areas (17) encounter the fastening area (15) and there can be fastened to the base element with the aid of a fastening means, symbolized in FIG. 3a by the staple 18.

Also shown in FIG. 3a are the information areas (16) of the information carriers. Between the latter and the fastening areas (17) there are the linear, flexibilized zones—which are expedient when a relatively stiff information-carrier material is used—symbolized by the small circles (19), said zones permitting the information carriers to be folded open.

FIG. 3b illustrates the label (1) according to the invention produced by bringing together and joining the information carriers (4) and the base elements (3) shown in FIG. 3a, and the arrows here show the action of placing the label (1) onto the package (2). In addition, FIGS. 3a and 3b show hold-closed extensions 11a and 11b which originate from the uppermost information carrier and from the base element and on which the interacting adhesive elements 5a and 5b are fastened.

The base element can also be part of the package itself. In this case, one area of the package constitutes the base element. As described above for a separate base element, this area of the package is divided into an information area and a fastening area for the fastening of the information carriers. If desired, the information area can be prepared, for example, as a markable, printable or magnetizable or optoelectronically readable surface to accommodate appropriate information, or can be equipped with an adhesive-friendly surface for the application of a self-adhesive label containing the information. Finally, it can also itself be provided with an adhesive layer, protected by a film if necessary, which permits any labels bearing information, which do not have any gumming or any contact adhesive, to be fastened on the information area of the package. As described above, the part of the package material provided as a fastening area can be prepared by means of an adhesive coating for the adhesive bonding of one or of a stack of information carriers. In addition, the other types of fastening described above for the stack of information carriers, such as rivets, staples or sewing, are practicable. If necessary, in these cases, the tearing strength, in particular the initial tearing strength, tearing-out strength and tear propagation strength can be increased, for example by applying resin or providing an underlay nonwoven, film or paperboard, in order to increase the strength of the connection between the fastening area and the information-carrier pack. FIG. 4 shows a blank made of package material before being folded together and adhesively bonded, on which an area is provided as base element (3a) and is subdivided into an information area (14) to accommodate the basic and/or safety information and into a fastening area (15) for fastening the information carriers. If desired, a field (6) with particularly important data, such as a label number, is also located within the information area. The information carriers which are fastened (hinged) to the base element such that they can be folded are flat blanks, whose area provided to accommodate the information, in terms of size and shape, expediently corresponds to the dimensions of the package area to be labeled, and therefore also generally to that of the base element. If the information carriers (4) are not to be fastened to one edge of the base element (3), in addition to the information area, designated by the number (16) in FIGS. 2, 3a, 3b and 4, they have a fastening area, designated by the number (17), between which, if necessary—that is to say if the material of the information carrier does not itself have a sufficient flexibility for the label to be turned over—there is a flexible connection (19) symbolized by small circles.

If desired, the information areas of the information carriers can be prepared, for example by producing writable, printable, reflective or magnetizable or other types of surface suitable for the storage and/or visualization of data, for the accommodation of appropriate, including optoelectronic, information, or they can be prepared for the application of a label containing the information. Finally, said areas can also themselves be provided with an adhesive layer, protected by a film if necessary, which permits any desired information-carrying labels which do not have any gumming and no contact adhesive to be fastened to the information areas of the information carriers.

The areas of the base elements can also be prepared in the same way to accommodate information.

As in the case of the base element, the position of the fastening area within the total area of the information carrier, and therefore also the size of the information areas located on both sides of the fastening area of the information carrier is selected on the basis of the requirement. In most cases, it is advantageous if the fastening areas of the information carriers and the fastening area of the base element are located at one end of the areas.

The connection between the base element and the information carriers can be made in various ways. For example, it is possible to connect the fastening areas of the information carriers to the fastening area of the base element rigidly by means of any desired known fastening means which acts between them—symbolized by the staple (18) in FIGS. 2, 3a and 3b, and to hinge the information areas of the information carriers to their fastening areas such that they can be folded.

This means that—as already mentioned above—in this type of fastening of the information carriers to the base element, there must be a flexible connection between the fastening area and the information areas—symbolized by the small circles (19) in FIGS. 2, 3a and 3b, if the material of the information carriers does not itself have an adequate flexibility for the label to be turned over.

If there is a low requirement for information, it is possible for only one information carrier to be fastened to the base element, which also functions as an information carrier. Such an individual information carrier can be formed very simply from an extension to the base element which is folded back at a flexible bending line.

As a rule, the considerable advantages of the label according to the invention are only realized in full when a great deal of information has to be provided, for which there is no space on a single information carrier. As a rule, therefore, a multiplicity N of information carriers are connected to the base element.

In the preferred type of fastening described above, the N information carriers are fixed to the fastening area of the base element as a stack with fastening areas located one above another. As a rule, 5 to 30 information carriers are fastened to a base element (N=5 to 30). Depending on the current space requirement, however, N can also be greater or smaller.

Instead of the information-carrier stack fastened to the base element and described above, the multiplicity of information areas can also be formed from a zigzag-folded strip of the information-carrier material.

The zigzag-folded strip can be a material strip originally separated from the base element, which is fastened with one end in the fastening area of the base element. However, it can also be a folded-back, strip-like extension of the base element itself. In addition, in this design of the information-carrier pack, on the side on which the information-carrier strip is located, the base element can be lengthened beyond the area of the package material by the thickness of the package, so that, if required, the folded information-carrier strip can be bent back on that side of the package opposite the base element.

The feature specification that the information carriers are fastened to the base element of course also comprises such stacked information carriers in which only the lowest information carrier is connected directly to the base element and all those located above are fastened indirectly to the base element via the intermediate information-carrier layers. It also comprises the embodiment of the label according to the invention which is illustrated in FIGS. 13a and 13b, in which information-carrier strips folded at the center are fastened, in bookbinding fashion, to an overhang of the base element. The information-carrier stack then results from the center of the folded information-carrier strips located one above another.

The fastening between the fastening areas of the information carriers and the fastening area of the base element can also be carried out with all known connecting elements. Used as preferred, known mechanical fastening means may be one or more staples or rivets, with which the fastening areas of the stacked information carriers are fastened to one another and to the base element. Another preferred type of mechanical fastening can be carried out by sewing, it being possible for monofilament or multifilament threads or else metal wires to be used as sewing material. However, it is also possible to use as the fastening means an adhesive, preferably a contact adhesive, with which the fastening areas of the stacked information carriers are bonded adhesively to one another and to the base element. Particularly advantageous are, for example, information carriers which, on the fastening area, are provided with a coating of adhesive, protected by a film if necessary. Depending on the mechanical equipment of the label producer, such a material may offer advantages in the production of an information-carrier stack on the fastening area of the base element.

The free edges of the fastening areas can be glued to one another by means of an adhesive in order additionally to impart a higher strength, for example for stapling, and to minimize the opening of the fastening area.

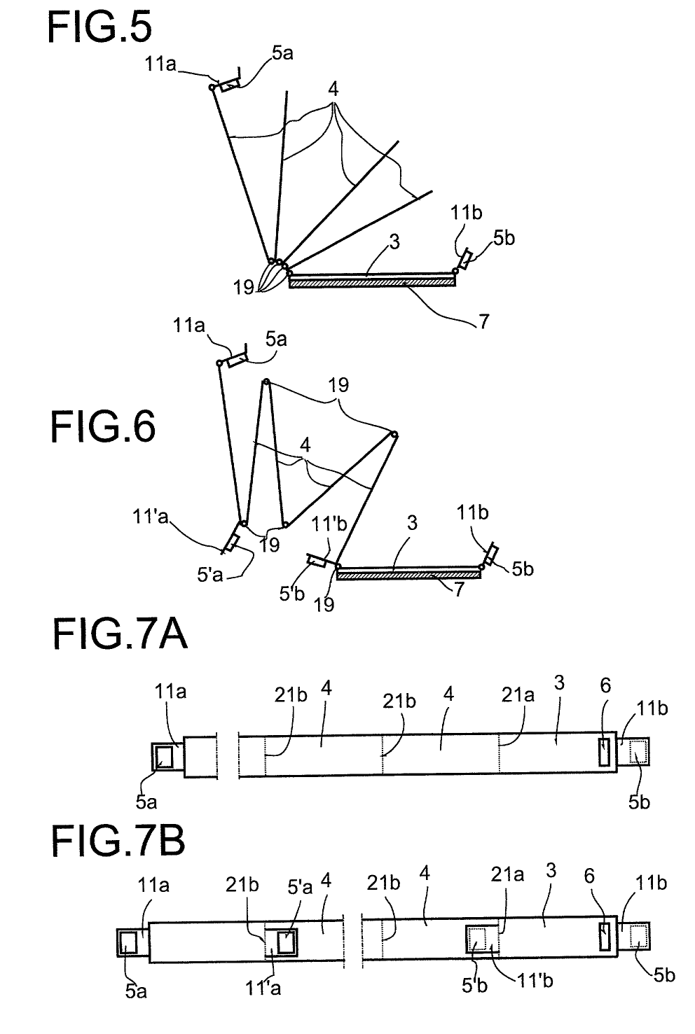

Fastening the information carrier to one edge of the base element or one edge of an overhang of the base element such that it can be folded is particularly expedient, uncomplicated and advantageous. The fastening to the edge is expediently carried out in the form in which the first, lowest information carrier (4) is fastened such that it can fold directly to the base element (3) or an overhang of the base element, each further information carrier (4) located above then being fastened to the previous one such that it can be folded. This can be achieved in two ways, illustrated in FIGS. 5 and 6; the higher information carriers can in each case be fastened to the edge of the information carrier located beneath with which the latter is fastened to its predecessor or to the base element (FIG. 5), or the higher information carriers can in each case be suspended at the free edge of the predecessor (FIG. 6). The foldable, flexible fastening is symbolized in FIGS. 5 and 6 by the circles (19).

In the zigzag arrangement of the information carriers according to FIG. 6, hold-closed extensions (11a, 11b, 11a, 11b) are provided on both sides of the stack. The hold-closed elements 11b and 11b shown by way of example in these figures, and all the adhesive elements 5a, 5b, 5′a and 5′b can be left out if the hold-closed extensions 11a and 11′a are provided with insertion ends (12) which, as illustrated in FIG. 1b, are inserted into the slot (10) present on the closure flap of a package. Of course, the lengths of the hold-closed extensions then have to be dimensioned such that they reach the slots (10) on the package, and the insertion ends can be inserted there.

The type of fastening illustrated in FIGS. 5 and 6 is most straightforwardly implemented by the base element and the information carriers being cut out of a coherent strip of a suitable flat material of adequate strength, on which, expediently, equally possibly desired hold-closed extensions (11a, 11b) and (11′a, 11′b) can also be cut and provided with adhesive elements (5a, 5b) and (5′a, 5′b).

In this case, the width of the strip corresponds essentially to the width of the package, the length is expediently a whole even multiple of the length of the package and, if desired, a length allowance of the size of the pack thickness. FIGS. 7a, 7b and 7c illustrate such a strip and the treatment of the strip described below. At one end of the base element, the strip is flexibilized by suitable measures on a line transverse to the longitudinal direction—illustrated in FIGS. 7a, 7b and 7c by the dashed line (21a)—so that it can be folded against the base element along this line. Then, in each case at the spacing of the pack length, there is a flexible transverse line (dashed lines 21b), so that a multiplicity of information-carrier areas is produced.

If zigzag folding of the information-carrier stack according to FIG. 6 is provided, the hold-closed elements 11′a and 11′b can be obtained from the areas of the uppermost or second uppermost and the lowest information carrier in the stack, as has been illustrated in FIG. 7b. Starting from a point on or close to a bending line (21a) or (21b), a cut is taken along the circumference of an area element (11′b) or (11′a) of appropriate size in the area of the information carrier, said cut ending at a point spaced apart from the starting point, on or in the vicinity of the aforesaid bending line. In FIG. 7b, this cut is illustrated by the continuous lines bounding the area elements 11′a and 11′b. This action produces material tongues which can be folded out of the area of the information carrier. These tongues form the hold-closed extensions 11′a and 11′b, which are subsequently provided with conjugate, cooperating adhesive elements 5′a and 5′b. It goes without saying that the tongue-like hold-closed extension 11′b can also be formed from the base element, and that the tongue-like hold-closed extensions 11′a and 11′b can also be produced separately and can be fastened, for example adhesively bonded, to the undamaged information carriers or the base element.

If a distance (22) of the magnitude of the pack thickness is desired between the base element and the information-carrier stack, as illustrated in FIG. 7c, the strip is first of all flexibilized transverse to its length at this distance from the end of the base element, at (21c), and this is then followed by the above-described flexible transverse lines (21b).

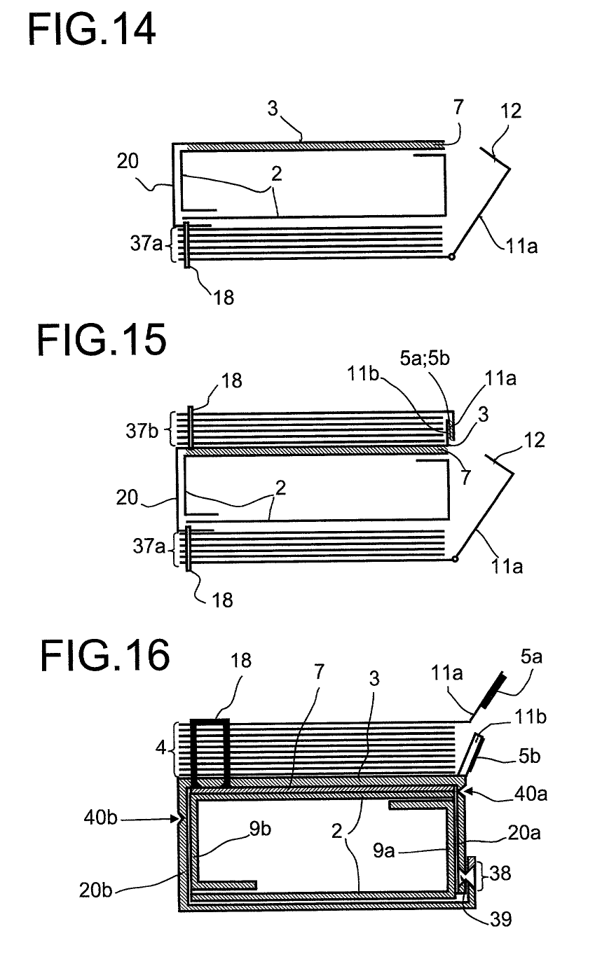

The information-carrier areas can then be laid together by zigzag folding to form an information-carrier stack, the embodiment of FIG. 6 being obtained, and if desired each two successively following information-carrier sections in the zigzag-folded strip—beginning with the second and third section - can be adhesively bonded by the mutually facing areas, the embodiment of FIG. 5 being obtained. The embodiment of FIG. 5 is particularly handy and, as a result of two material layers in each case being laminated to each other, is also particularly robust. If a section of the length of the package thickness has been interposed between the base element and the first information-carrier area, then the information-carrier stack can be placed on the side which is located opposite the fastening side of the base element (similar to the illustration in FIG. 14).

Alternatively, but technically considerably more complicated, the fastening means used can be one or more eyelets which are fastened or integrated in the base element and engage in marginal holes in the fastening areas of the information carriers and in which the information carriers can be turned in the manner of ring-bound pages. In a similar way, the fastening means used can be a spiral which is fastened in the base element and engages in marginal holes in the fastening areas of the information carriers and in which the information carriers can be turned in the manner of spiral notepad pages.

In the case of this type of fastening, no flexible connection is needed between the fastening areas and the information areas of the information carriers.

The base element and the information carriers can consist of the same or different, known flat materials. The selection of the material depends on the functions which are assigned to the components of the label and on the required mechanical strength, for example the required tearing strength and aging resistance. One special requirement on the material of the base element is that it is suitable for the production of firm and permanent adhesively bonded connections to package materials but that it is also suitable, in the information area, for marking or for other types of information storage, for example by means of printing, embossing, stamping, burning-in, magnetization or optoelectronic writing, preferably for printing or bonding oversticking with marked labels. This is similarly true for the material of the information carriers. The latter material must also, on one hand, permit the satisfactory fastening of its fastening area to the base element, but on the other hand must be suitable for simple, permanent storage of information, for example comprehensive marking, on both sides of the information area.

Not least, the materials should permit simple production and the material price should not be prohibitive.

Materials of which the base elements and the information carriers can consist are, for example, paper, paperboard, in particular such with synthetic resin or long fiber reinforcement, nonwoven material, in particular resin-bonded or autogenically bonded spun bonded fabrics, synthetic film, metal foil or composite materials consisting of two or more of these materials.

If the base element and/or the information carriers consist of a single-layer material, then it is occasionally possible for not all the requirements, for example relating to stability or information storage capacity, to be met to the maximum extent, instead a compromise between the individual requirements is necessary. Nevertheless, it is generally possible to meet the requirements which can sensibly be placed on a label according to the invention, even using a single-layer material.

For particularly high demands, it is advantageous if the base element and/or the information carriers consist of a multi-layer material. For example, by combining various materials for a carrying layer, a storage layer, for example a magnetic or electrooptical storage medium, for an adhesive layer and/or a protective layer, particular advantages for the production and use of the labels can be achieved.

One example is an information carrier consisting of a single-sided or double-sided self-adhesive material covered with a pull-off protective film.

On such an information carrier, following the removal of the protective film from the information areas, it is possible to stick marked labels, which themselves do not have to have an adhesive face. The protective films in the fastening area can then be removed, and the information carriers can be bonded adhesively to form a stack. Such a material can therefore lead to rationalization in the production of the multi-ply labels according to the invention. A further example is a base element which has an overhang on which, as illustrated in FIG. 13a, a multiplicity of information carriers are stapled, and which is stiffened, for example resin-stiffened in the adhesive and information areas, and is highly flexible in the overhang area. Such a material combination makes it substantially easier to open the pages of the information carriers, as illustrated in FIG. 13b.

A significant feature of the labels according to the invention is that the information carriers are fastened to the base element such that they can be folded. If the fastening is not carried out, as described above, inter alia, via a flexible connection between one edge of the information carrier and one edge of the base element, or one edge of the preceding information carrier, or by means of eyelets or spirals which engage in an appropriate perforation in the fastening area of the information carriers, it is necessary to provide, between the fastening area and the information area of the information carriers, a connection which permits pages of the information carriers to be opened, that is to say which permits any desired small angle to be set between the two faces. It should be possible for this angular change to take place within the shortest possible distance, in order that the entire information area of the information carrier can be viewed when the pages are opened, so that the information can be read without difficulty. In the simplest case, the preferred case, the information carrier consists of a material which is so flexible, for example paper or nonwoven, that the pages of the information-carrier stack can be opened without difficulty, as in a book. Then, when the pages are opened, a more or less sharp bend or bending line is formed without difficulty in a narrow area between the fastening area and the information area of the information carrier, and permits the entire information area to be viewed. Special measures which permit the setting of an angle between the fastening and the information area which is necessary for unimpeded opening of the pages are not necessary in this case.

If, on the other hand, the information carriers in an information-carrier stack consist of materials which are naturally less flexible, such as paperboards or resin-reinforced papers, then such a simple design is no longer possible, since during the attempt to open the pages of the information-carrier stack, an excessively large radius of curvature in the information areas is built up, which makes reading the information very difficult or impossible, or cracks or fractures in the information carriers are formed, which can likewise lead to a loss of important information. Therefore, in this case, design measures have to be taken which make it possible, in spite of the stiffness of the material, to set an angle between the fastening and information areas of the information carriers which is necessary to open the pages, the intention being for the curvature of the material to take place on the shortest possible, strip-like section between the fastening and information areas.

In principle, the requirement can be met by any known design which functions in the manner of a hinge. An expedient, practicable and acceptable-cost solution is for a narrow area of particularly high flexibility to be provided on the straight boundary line between the fastening area and the information area of the information carrier, ensuring the required flexible connection between the areas. One precondition for this is that the flexible connection between the information carrier and its fastening face is produced by a joining element made of a low-fatigue, flexible material.

For example, the flexible connection between the information carrier and its fastening face can be produced by means of fibers which extend between the information carrier and the fastening face and are permanently incorporated in the latter. These can be fibers of the fibrous material from which the information carrier has been produced, or they may be reinforcing fibers which are undetachably embedded in the flat material, at least in the area of the bending line.

If the fastening face and the information face consist of a coherent piece of a suitable material, the flexible connection can be formed by a low-fatigue folding line between the subareas of the information carrier. Such a pre-planned bending line can be achieved by means of a deliberate change in the material structure which is restricted to the narrow bending area and leads to an increase in the flexibility. For example, the bending line can be preformed by bending the material many times on the planned line.

However, the specific increase in the flexibility can also be implemented by a linear reduction in the material thickness, provided by scoring, for example, or by a reduction of the method material located on the bending line, produced by means of perforations.

If the information carrier consists of two more layers of different flexibility, then the layers of lower flexibility can be slit or perforated at the envisaged bending line between the fastening and information areas of the information carrier.

A hold-closed means can be implemented in very different ways in the production variants A and B of the label according to the invention. As a generic term for all the components of the label according to the invention which serve to hold it closed, in the following text the term “hold-closed element” will be used.

A simple hold-closed means can consist, for example, of a reversibly extensible thread or band (for example rubber band) fastened at two points spaced apart from the fastening area on two different edges of the base element, it being possible for said thread or belt to be drawn over the information-carrier stack or over one corner of the information stack. It is also possible for two such simple hold-closed means to be provided on adjacent comers of the stack.

In another embodiment of variant A, a flexible extension (hold-closed extension) begins either from the base element or from one of the lowest, preferably the lowest, information carrier in the stack at at least one location, spaced apart from the fastening area, on one edge, preferably on the edge opposite the fastening area, it being possible for said extension to be made, by bending, to overlap the uppermost information carrier or an extension of the same positioned in accordance with the purpose. In the overlap area, the overlapping parts are designed in such a way that they form a hold-closed means by interacting. Hold-closed extensions can be fitted subsequently to prefabricated information carriers and base elements. However, they are expediently cut at the same time as the information carriers are cut to size.

Such a hold-closed means can be configured purely mechanically. For example, one of the hold-closed elements can be constructed as a tab, knob or in another way as a male part of a plug connection, which can be inserted into an opening, for example a slot or another part formed as a female part of a plug connection of the other hold-closed element, the elements of the plug connection being subjected, during insertion, to a more or less severe elastic, reversible deformation, which is recovered after the elements have been united completely and therefore produces a firm but detachable connection.

The hold-closed elements can also have adhesive areas, at least in the overlap area, which effect a firm but detachable connection by interacting and which are positioned in such a way that they come to rest on each other when the flexible extension starting from the base element or one of the lower information carriers is brought into contact with the uppermost information carrier or its extension.

Suitable pairings of adhesive areas are, for example, a contact-adhesive area combined with an adhesive-repellent smooth layer area or the elements of a surface closure, namely one area provided with small hooks and one provided with loops. The term “adhesive-repellent” here designates a material which, although an adhesive layer adheres to it, the adhesive connection can be separated again without any significant damage to the layers, it being necessary to apply a separating force which lies within a predefined bandwidth. So-called smooth layers, such as a silicone layer, are adhesive-repellent.

If the closure is made by means of a contact-adhesive area interacting with an adhesive-repellent area, it is expedient to provide an extension on the base element or on one of the lower information carriers, preferably the lowest one, and if necessary also on one of the uppermost information carriers, preferably the uppermost one. The extension which starts from the base element or one of the lower information carriers is sufficiently long that, after being bent upward, preferably overlaps one of the upper information carriers, preferably the uppermost information carrier, or overlaps an extension on the latter which is bent downward. In the overlap area, one of the overlapping elements is provided with an adhesive layer on that area which comes into contact with the other element, and the other element is provided at the appropriate location with an adhesive-repellent smooth area. To provide a reversible closure, the closure elements are bent together, brought into contact at the functional areas and pressed together.

This embodiment permits two options for closing the label: if the extension starts from the base element, then the closing action fixes the entire information-carrier stack firmly on the package. If, on the other hand, the extension starts from one of the lower information carriers, preferably from the lowest one, then after the closure has been closed, the information-carrier stack can be folded open as a pack, so that the base element becomes accessible. In a special embodiment which is easy to produce, a closure extension starting from the base element can be implemented as follows:

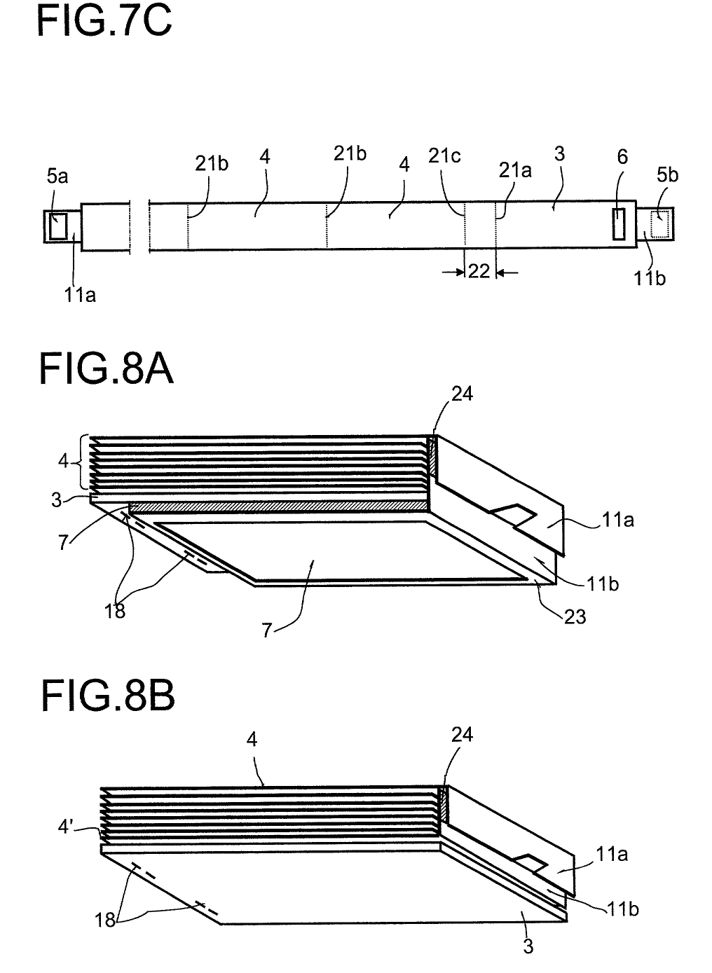

From a two-dimensional structure which is laminated on one side with silicone paper or a similar, adhesive-repellent material, a blank is produced of the size of the adhesive area of the base element, said blank having the required closure extension. The inner area of this blank is then stamped out in such a way that a frame (FIG. 8a, No. 23) is produced, on which the hold-closed extension (11b) is seated. This frame is placed with the adhesive-accepting area on the base element and is thus fixed. The adhesively bonded frame leaves the major part of the adhesive area (7) of the base element free so that the latter can still be fixed reliably to the package.

FIG. 8a illustrates such an embodiment of the multipart label according to the invention in a view obliquely from below, in schematic form and not to scale.

The figure shows the frame (23) fixed on a base element (3) by the adhesive layer (7) and the extension (11b) which adjoins said frame and which, on the area which can be seen in the drawing, has the silicone-paper layer, as well as the extension (11a) which is placed with its adhesive layer (24) on the extension (11b), the adhesive layer (24) coming to rest on the silicone side of the extension (11b).

FIG. 8b illustrates, in a plan view obliquely from below and schematically, not to scale, a closable embodiment of the label according to the invention, in which the hold-closed extension (11b) does not start from the base element but from the lowest information carrier (4′).

The variant B of the hold-closed means has the advantage that the label itself has to have only a single hold-closed element, and that the activation of the hold-closed means can be carried out with the aid of a design feature which is in any case present on the package. The package therefore does not have to be modified in any way with respect to a package not labeled in accordance with the invention.

This variant is implemented, for example, in the embodiment which can be seen from FIG. 1b and the associated description.

Here, the uppermost information carrier, or one of the upper ones, has a hold-closed extension with an insertion end (12) which can be inserted into the gap opening (10) present between the closing flap (9) and the outer (8) of a package.

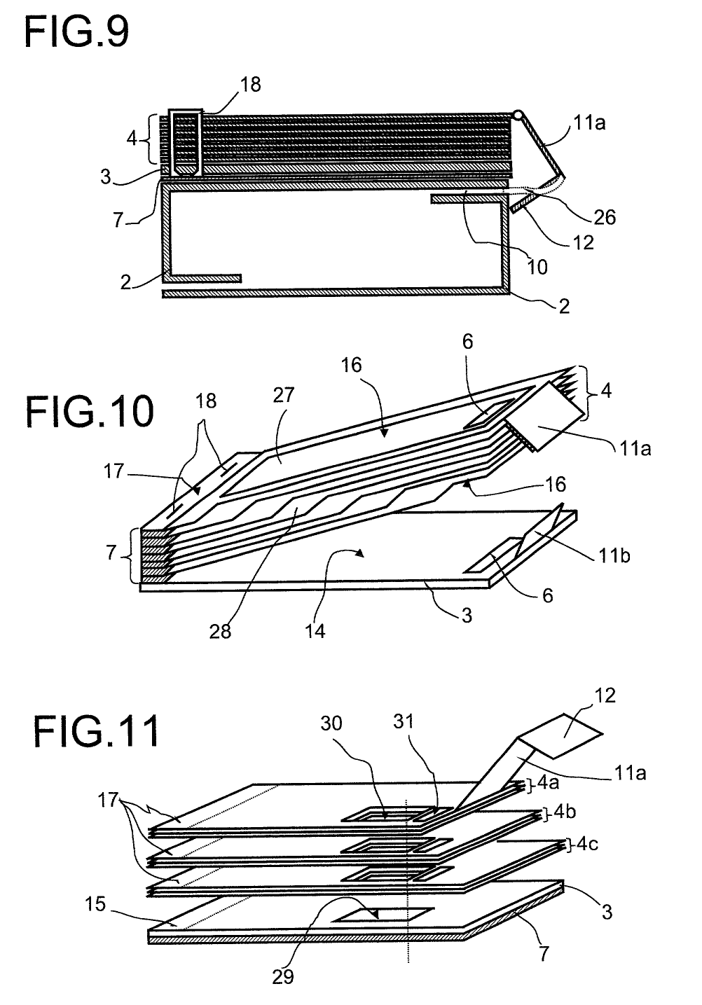

A further possibility, illustrated in FIG. 9, is, for example, for the label to be fixed on that area of the package which adjoins the slot (10). FIG. 9 shows a schematic illustration, not to scale, of a section through a folding-box package (2), which is provided on the area adjacent to the slot (10) with a label according to the invention in design B. In this case, the extension (11) is shorter, by the thickness of the package, than that illustrated in FIG. 1b. Surprisingly, it has been shown that a not excessively short insertion end (12) of the hold-closed extension (11) constitutes a preferred means of securing the label against inadvertent opening. This could be attributed to the fact that, in order to open the hold-closed means, it is not only necessary to overcome the frictional forces produced by the extension being clamped in the gap or slot (10), but that at least the insertion end (12), and possibly also the extension (11), has to be bent elastically in its longitudinal direction to be opened and to be closed, as is shown schematically in FIG. 9 by the dashed illustration (26) of the insertion end. The work necessary to produce this deformation must be applied both during closing and during opening and prevents the label according to the invention being able to open inadvertently.

If the hold-closed means is to be secured even better against inadvertent opening, then the hold-closed extension (11) can be provided at the sides with short cuts—designated by the number 25 in FIG. 1b—as are known from the closing flaps of conventional folding-box packages, which snap in behind the side edges close to the base of the trapezoidal box elements (13).

As FIG. 2 shows, information can be applied to the label according to the invention both on the free side, the information area (14) of the base element (3), and on both sides of the information areas (16) of the information carriers (4).

A field (6) for a label identification symbol is preferably reserved both on the base element and on the information carriers, in particular on the top of the uppermost information carrier. It is also possible to reserve a field for a label identification symbol on each information-carrier side. Such a symbol permits error-free collation of the information-carrier labels, possibly also the automatic labeling of packages which have the same identification symbol, and therefore provides a significant contribution to drug safety. The identification symbol can be, for example, a letter and/or number combination or else an icon which can be identified unequivocally, possibly even by automatic systems, or a bar code.

It is expedient if, on the information area of the base element, in addition to the label identification symbol, indispensable basic and/or safety information, in particular identification information, about the package content is applied in an easily readable world language.

This indispensable basic information is preferably also further applied to the top of the uppermost information carrier fastened to the base element.

In view of the wide spread of the English language and its easy readability, it is preferable to apply the basic and identification information in this language.

All the desired information can be applied to the information areas of the multi-ply label according to the invention by marking, printing, embossing, stamping, or burning in, using clear text or in the form of digital-optical information, such as bar codes, or else by means of magnetization or electrooptical writing, for example by means of a laser, and/or the base element and the information carriers can have stuck to their information areas labels on which the aforementioned information is displayed. If the information carriers have film-protected adhesive-coated information areas, then adhesive-free labels can be used, otherwise adhesive labels are used.

The information can also be stored magnetically on areas which are prepared for magnetic information storage. Given suitable selection of the carrier material, magnetic and printed reproduction of the information on the information carrier can also be provided simultaneously.

The large amount of space provided on the label according to the invention makes it possible to set down all the necessary and/or desired information in a desired and orderly manner. For example, it is possible to provide the individual information carriers with items of information selected specifically for a country. The finding of such ordered information is made particularly simple if an aid to searching, preferably an index (28), is provided, cut into at least one edge of the information-carrier stack.

FIG. 10 illustrates, schematically and not to scale, an oblique view of a label according to the invention, whose information carriers (4) have an index (28) on the front long edge. In this exemplary illustration, a label (27), on which the information field (6) is reserved for essential information, for example a label number, is stuck on in is the information area (16) of the upper information carrier. A similar field (6) is also located on the information area (14) of the base element (3). The hold-closed extension (11a) has an adhesive element, for example an adhesive layer, which, interacting with a smooth area of the hold-closed extension (11b), for example, results in a hold-closed means which can be activated and deactivated. FIG. 10 also shows a combination of adhesive layers (7) and staples (18), by means of which the information carriers are fixed to the base element in the fastening area (17). Of course, all known fastening means, including those (7) and (18) shown in FIG. 10, can be used individually or, if it is advantageous, in any desired combination with one another.

It is also possible for the other edges, in particular the second long edge of the information carrier, to have an index. This is particularly advantageous when, for example, the front sides of the information carriers bear ordered, country-specific information, but the rear sides, by contrast, have this information sorted by subject. It is then possible to look for country-specific information in one index and subject-specific information in the other. A further possibility for searching in a specific manner in accordance with different criteria exists in providing an index strip which is printed differently on the front side and rear side in accordance with the various ordering methods.

An index can also be obtained by information carriers which relate to different ordering features having a different length or width, while all the information carriers which relate to the same ordering feature have essentially the same dimensions. The differences in the dimensions are selected in such a way that the steps produced are sufficient to accommodate the keywords or information about the content.

If the size of the information carriers permits, the information carriers belonging to one ordering feature, for example a specific language, can also again be stepped in terms of length, or else carry a register on a different side, so that within one stack of information carriers which are associated with a specific ordering feature, a fine subdivision is again carried out. In principle, this subdivision process can be continued until the size of the steps which result is no longer adequate to accommodate index information in a recognizable form.

However, indexing does not necessarily have to be carried out in clear text, instead other indexing options can also be used, for example the application of a color code or the use of information carriers of different colors.

Other known search aids can also be applied to the information-carrier stack, such as colored edge markings together with an index fitted to the cover sheet or to the base element, or groove-like marginal cutouts in the stack which, starting from the top, end at an information carrier which belongs to a specific keyword and permit the relevant keyword to be found there.

FIG. 11 illustrates a further particularly expedient embodiment of the label according to the invention, by way of example, in an exploded illustration in an oblique view, not to scale and in schematic form. Said label has, on a subarea (29) of the base element (3), specific important variable data, such as patient numbers, batch designations, use-by dates and the like.

Above the base element, FIG. 11 shows three information-carrier stacks (4a, 4b, 4c), which, because of their different length, when they are lowered onto the base element in the direction of the arrow, result in a stack with an index strip. Each of the three stacks contains information in a language assigned to it. All the information carriers have a window-like opening (30) which, when they are stacked, result in a viewing window which is continuous down to the base element and through which the data field (29) of the base element is visible. At least the uppermost sheet of each of the three stacks has a reserved field (31) in the vicinity of the window opening (30), on which field the significance of the data displayed on the field (29) is indicated in the language associated with this stack. In order to form the label according to the invention, the parts (4a), (4b) and (4c) are lowered onto the base element (3), and the ensemble is permanently connected together in the area of the fastening areas (15) and (17).

This embodiment has the advantage that permanent standard information can be present in the fields (31) of all the information carriers, and the variable information (patient or batch numbers and the like) has to be noted only once on the field (29) of the base element. This design not only facilitates the production of the label but also avoids sources of error and mistakes. It therefore provides a further considerable contribution to the safety of drugs, for example in clinical studies. In the example illustrated in FIG. 11, the field (29) is located in an area of the base element (3) which is close to one edge. This representation is particularly well suited to illustrating the principle of this design. Of course, if desired the information field (29) can be applied to any other subarea of the base element. The window apertures in the information-carrier stack are then positioned appropriately.

The hold-closed extension (11a) depicted in FIG. 11, with the adjacent insertion end 12, corresponds to design B of the label according to the invention. After this label has been fixed on a folding box, the insertion end (12) can be inserted into the slot opening (10) resulting from the design of a folding box, which activates the action of holding the label closed.

In a further, preferred embodiment, at least one of the information carriers is configured in such a way that it can be removed from the information-carrier stack, wholly or partially, if necessary also in a number of subsections. It is preferable for the uppermost information carrier in the stack to be selected for this configuration. In this case, this information carrier is configured in such a way that the complete or partial removal from the stack cannot be carried out inadvertently but only by means of deliberate, planned handling. Configurations which achieve this purpose are known per se. For example, the information carrier can be perforated or scored (notched) along specific lines, which can also run in a wavy shape, or can be prepared for the removal of the subsections on the lines provided for the separation in any other way, for example by deliberately reducing the tearing strength of the material. If the information carrier is to be removed as a whole from the stack, it is possible, for example, for perforation or score lines to be made around a staple situated in the fastening area. This means that the information carrier can be removed from the stack together with that part of the fastening area which is not gripped by the staple, while that part of the fastening area which is held by the staple remains on the stack. In a similar way, in the case of a stack which is adhesively bonded, the information carriers can be subdivided into fastening area and information area by means of perforated or pre-scored (notched) separating lines. Of course, the measures which permit the partial or complete deliberate separation of an information carrier from the stack can also be used in combination with one another.

In a further refinement of this embodiment, the separable information carriers or their parts are configured in such a way that they can be fixed to other areas. For example, these information carriers can have a self-adhesive layer protected by a pull-off film on the side opposite the information, or they can be provided with water-activated gumming.

In a still further refinement of the label according to the invention, one or more information carriers in the stack, preferably the uppermost one, is configured such that one or more subareas of the same, which are located at any desired locations on the information carrier and can have any desired shapes, can be separated from the assembly. The separable subareas are bounded by boundary lines or curves on which the material of the information carrier is weakened by known measures in such a way that the subareas can be separated from one another and/or from the remainder of the information carriers remaining in the label assembly along these boundary lines, or they are bounded by the edges of the information carrier. The known measures which are used to weaken the material along the boundary line are selected in accordance with the purpose, depending on the type of bounding and the shape of the section to be separated. Known suitable measures are, for example, scoring (notching) or perforation, it being possible for the perforation holes also to be elongate holes (slits), between which only point connections remain between the separable part of the information carrier and that part remains in the label assembly. If the form and location of the separable area elements permit, it is also possible for material fatigue to be provoked along a boundary line, for example by means of bending, said fatigue permitting the section to be separated along this line. In addition, there is the possibility of slitting the carrier material uninterruptedly through the entire material thickness over part of the length of the boundary line, and of preparing for the separation only the unslit part of the boundary, by means of which the separable section is still connected to that part of the information carrier remaining in the assembly, in the manner described.

Particularly advantageous is a flat information carrier from which one or more subareas bearing information can be separated, are located at any desired locations on the information carrier and can have any desired shapes and which, following separation, can be stuck onto other areas, consisting of a flat, at least three-layer material, the lower layer being an adhesive-repellent layer. In this connection, adhesive-repellent also refers to a material which, although an adhesive layer adheres to it, the adhesive connection can be separated again without significant damage to the layers, it being necessary to apply a separating force lying within a predefined bandwidth. So-called smooth layers, such as a silicone paper layer, are adhesive-repellent. The adhesive-repellent layer is adjoined by an adhesive layer and, located above the latter, is at least one adhesive-accepting layer bearing the information. In an information carrier composed in this way, a section to be separated can then be prepared by means of purposeful double notching along at least one boundary line, such that when it is separated from the information carrier along this boundary line, a free strip of adhesive remains on the separated section.

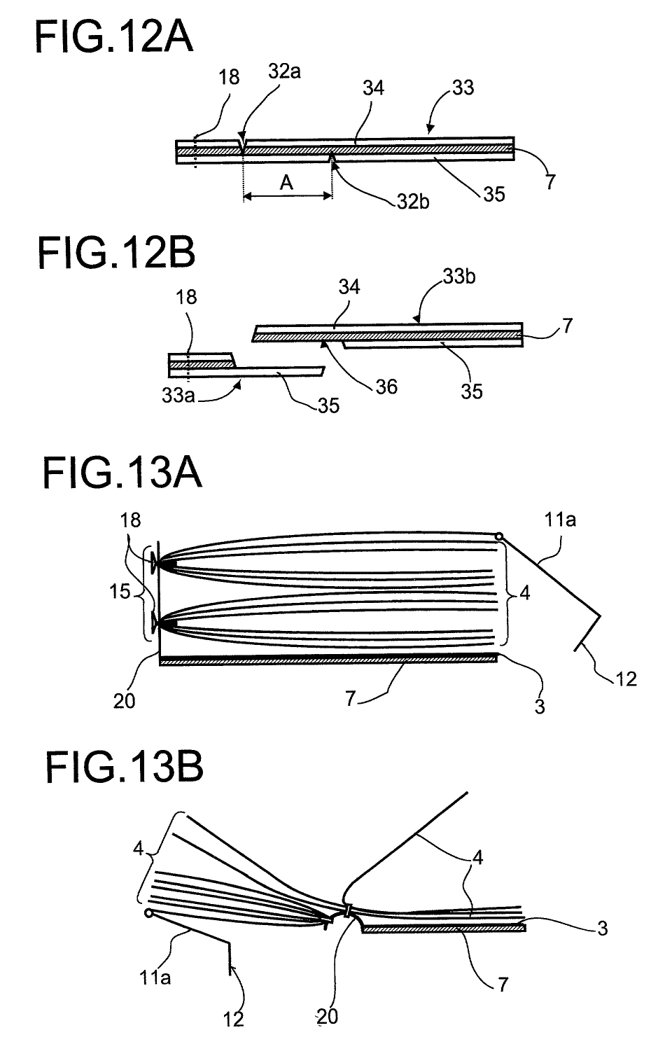

In order to implement such double notching, the information carrier is notched from both sides by means of spaced-apart notches such that one notch (number 32a in FIG. 12a) is led directly on the envisaged boundary line from the topside, through the information-bearing layer(s) and the adhesive layer, as far as the adhesive-repellent layer, the second notch (32b), preferably essentially parallel to the first, severs only the adhesive-repellent layer from the underside, and such that the two notches are at a predefined spacing A from each other. In this case, the notch led from above is located on the envisaged boundary line, that led from below is, by contrast, displaced by the spacing A toward the center of the area element to be separated. FIG. 12a depicts, by way of example and not to scale, a cross section through a section of a three-layer information carrier (33) which is provided with such double notching. In this figure, it is possible to see the information-bearing layer (34), which is connected by the adhesive layer (7) to the adhesive-repelling layer (35), the two spaced-apart notches (32a) and (32b) and the staple (18) with which the information carrier is fastened to the labeled package.

If force is applied to a section of an information carrier prepared in this way, as shown in FIG. 12b, said information carrier will be separated at the notches into the two parts (33a) and (33b) in such a way that the separated section (33b) is provided, at the separated edge provided with the double notch, with a free adhesive strip (36) of width A, with which it can be stuck onto another area if desired.

Such a measure can, for example, increase the safety of clinical studies, can make documentation easier for the treating doctor or provide the patient with reliable information about the medicine.

The staples illustrated in FIGS. 12a and 12b can of course be replaced by another fastening means. Such an information carrier, provided with the above-described double notching, can also be fastened in any manner known per se to containers to be labeled, independently of the multipart label according to the invention described above. It therefore also intrinsically constitutes an inventive element of the present invention.

In addition, it is possible to provide one or more information carriers in the stack, preferably the uppermost one, with one or more labels bearing information, which can be pulled off, wholly or partially, from the information carrier. This can be made possible, for example in a manner known per se, by at least that part of the label envisaged to be removed—which can be divided off from the rest of the label, if appropriate, by means of perforated or prescored separating lines—resting on an area of the information carrier which is provided with an adhesive-repelling covering. The label then also sticks at these locations in such a way that it cannot be separated inadvertently, but can pulled off the information carrier deliberately and with the expansion of not too low a force. It can be made easier to pull off if an adhesive-free grip strip or tab is provided on one side or corner of the label or part label to be removed. In addition, it is possible for example to stick the labels on the information carrier over only part of the area and, between the adhesively-bonded and the non-bonded part, to provide one or, if needed, more tearing lines, which permit the non-bonded part label to be torn off. Of course, other known measures which satisfy the intended purpose can also be used. Combinations of these measures can also be used for the purposeful configuration of the label according to the invention. There is also the possibility of providing the information present on the tear-off label also on the area which is covered by the tear-off label before it is torn off.

As already mentioned above, the size and the shape of the base element is not strictly restricted to the size and shape of the package area to be labeled. Instead, the base element can be both smaller than the packaging area to which it is to be fixed or can project beyond it, forming an overhang area (20). Such an overhang can be advantageous for specific configuration or application of the label according to the invention. For example, specific possibilities for fastening the information carrier (4) to the base element (3) result if the length of the overhang area corresponds to the width of the fastening area.

If the width of the overhang is chosen to be as large as the thickness of the package, this provides the advantage that the information-carrier stack can be placed on the trough side of the pack.

FIG. 13a shows, in schematic form, an embodiment of the label according to the invention in which the information carriers (4) are fastened to the overhang (20) of the base element in the manner of bookbinding, and the base element is provided with an adhesive layer (7). The information-carrier stack then results from the centrally folded information-carrier strips located one above another. In the case of this type of fastening, it is particularly advantageous if the overhang has a particularly high flexibility since, as FIG. 13b illustrates, the pages of the information carrier can then be turned particularly easily. FIGS. 13a and 13b show hold-closed means of design B, with the hold-closed extensions (11a) and the insertion ends (12) which, after the label has been fastened to a package, can be inserted into the slot openings (10, FIG. 1b).

In this figure, too, the small circle (19) symbolizes a flexibilized zone, which is necessary when the flexibility of the information-carrier material impairs the free mobility of the hold-closed extension.

It may occasionally be advantageous if, as illustrated schematically in FIG. 14, the information-carrier stack (37a) is placed on that side of the package (2) which is opposite the side connected to the base element. This structure may be made possible if the length of the overhang area corresponds to the sum of the height of the package and the width of a fastening area. The fastening area of the base element is then expediently located at the end of the overhang area projecting beyond the package area. Also illustrated in this figure is a hold-closed means of design B, with the hold-closed extension (11a) and the insertion end (12) which, after the label has been fastened to a package, can be inserted into the slot opening (number 10, FIG. 1b).

In this figure, too, the small circle (19) symbolizes a flexibilized zone, which is necessary when the flexibility of the information-carrier material impairs the free mobility of the hold-closed extension.

This manner of fastening the label according to the invention to the package also opens up the possibility of applying two information-carrier packs (37a) and (37b) to one package (2), as shown schematically in FIG. 15. The stack (37a) is provided with a hold-closed means of design B, the stack (37b) is provided with a hold-closed means of design A, it being possible here, too, for any required flexibilized zones to be inserted between the upper information carrier and the extension (11a) and between the base element and the extension (11b).

Base-element overhangs of suitable length can also be used as hold-closed extensions.

A further possibility of using a base overhang is to lead it over the gap or slot opening (10, FIG. 1b) present between the closing flap (9) and the outer (8) of a package and to fix its end permanently to the package outer or the closing flap on the other side of the gap. Such a label encloses the packing material in the manner of a wrapper.

Such a security closure provides the user of the pack content with the security of obtaining an originally closed container which actually contains the content indicated on the label. Such security closures can also be varied in different directions in a simple way. For example, the base overhang can be sufficiently long that it reaches once along the entire package, and its end is permanently connected to that side of the base element which is opposite its attachment. In this case, the wrap around the package is arranged in such a way, for example along the sides of the closure tabs, that the package cannot be opened without severing the base overhang wrapping around the pack at some point. In addition, it is possible to provide, on both sides of the base element, overhangs which together are sufficiently long that, after wrapping around the package, they still overlap to such an extent that the ends can be permanently connected to each other. One or two locations on these overhangs of the base element, closed to form the wrapper, can be prepared to be severed. For example, they can be weakened by a notch, a perforation or by scoring, or can simply be marked by a printed scissors symbol.

FIG. 16 shows, in schematic form, a package (2) which is completely enclosed by the overhangs (20a; 20b), which are permanently connected in the overlap area (38) by a connecting means (39), for example a staple, a rivet, a welded point or an adhesive bond. As a result of the wrapping, the closure flaps (9a; 9b) are covered, which secures the package against unauthorized opening. At the intended fracture lines (40a and 40b) running transversely with respect to the overhang, the overhang material is weakened, for example by scoring, perforation or other known measures, such that it can be severed there by the user.

In addition, there is the possibility of configuring base overhangs in such a way that they can fulfill more than one function. In a multipart label according to the invention of design B, the uppermost information carrier, or one of the upper information carriers, can have a hold-closed extension with an insertion end and, in addition, a security extension, which can be fixed permanently to the package on the other side of the gap opening (10).

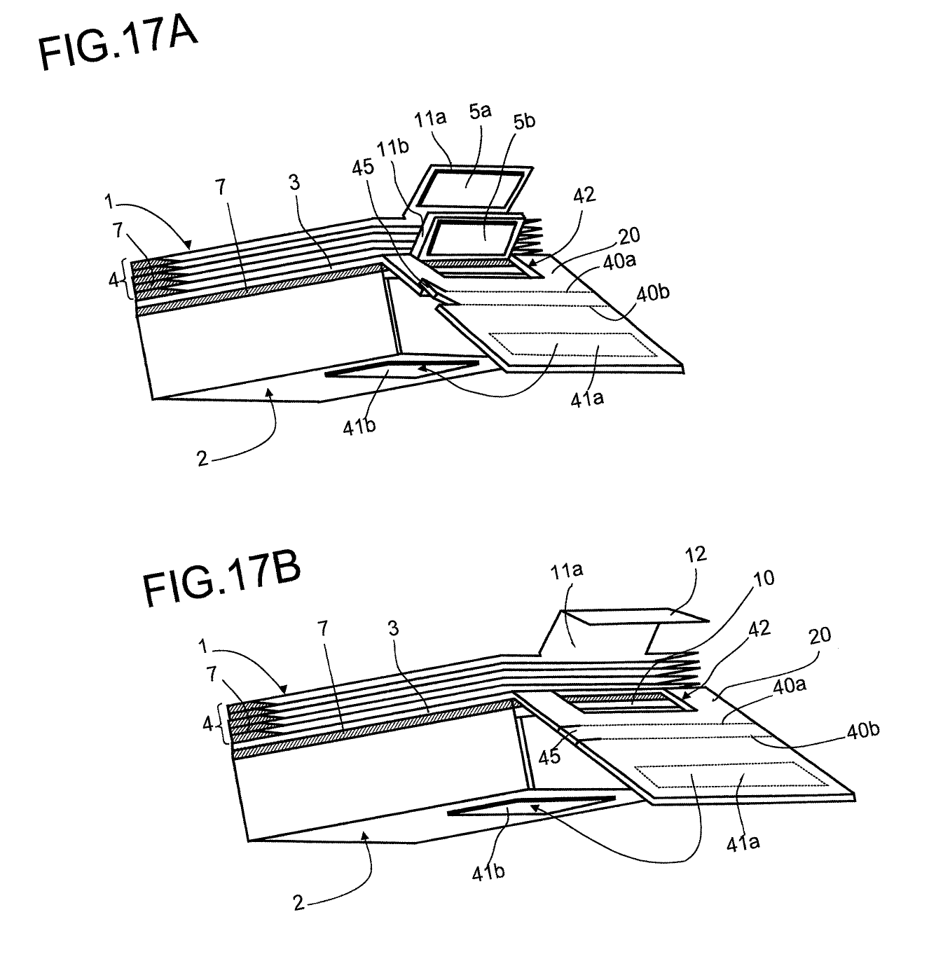

Such a dual function can be implemented, for example, by the base overlap being subdivided by one or more longitudinal cuts such that the narrow strips produced fulfill different functions. The width of the individual strips formed in this way can be equal or different, and is selected in accordance with the function envisaged for them. For example, a strip cut from the base element can be pulled over the closure flap of the package and fixed permanently to the outer of the package, so that it functions as a security closure, while a second strip is used as a hold-closed extension (11b). It is also possible, by means of two longitudinal cuts which begin at the end of the base element and are not led over the entire length of the overhang, and a cross cut which connects the former, to cut a tongue out of the overhang, said tongue still being connected to the base element on one side. The tongue can then function, for example, as a hold-closed extension, the remainder of the overhang can function as a security wrapper. A package having a label according to the invention of the above-described design is illustrated in FIG. 17a in an oblique view, not to scale. The hold-closed extension (11b) is formed by a tongue cut out of the overhang 20. At the end of the overlap, a fastening means (41a) is provided which, interacting with a fastening means (41b) present on the outer of the package, permits permanent fixing of the overlap to the package. The overlap can be severed, preferably along the intended fracture lines (40a and 40b), if necessary with the involvement of a grip tab (45), and the package can then be opened.

If an overhang functioning as a security wrapper is used with a label of design B, then, in the area of the package slot (10), a window (42) of the width of the hold-closed extension is provided, through which the insertion end (12) of the hold-closed means can be inserted into the slot (10).

FIG. 17b illustrates an example of such a design.

Of course, a means of securing the package against being opened can also be provided, irrespective of the application and/or design of the label according to the invention, in any other known manner which permits the package to be opened only by damaging or destroying the security elements. Such security elements produce a permanent, positive connection between the outer face (8) and the end face (closure flap) (9) of the package. Such a permanent connection can act within the gap (10), for example, such as adhesive areas or points which are applied there and which connect the inside of the outer (8) of the package to the insertion tongue of the closure lid (9). It is generally more advantageous if the security element, like the above-described wrapper, made of a strip of a severable material, is fixed at two arbitrary locations on either side of the gap, stretching tautly over the gap (10). If such a security strip corresponds to the width of the package, it covers the gap (10) completely. If use is made of a label according to the invention whose hold-closed means corresponds to design B, then a slot-like opening is made in the width of the hold-closed extension (11), in the area of the slot (10), or use is made of a security strip which is narrower than the width of the package, so that part of the slot (10) remains free, into which the hold-closed extension (11) can be pushed. Instead of a single security strip of this type, two strips can also be used, which are jointly narrower than the width of the slot, so that the hold-closed extension can be pushed in between them.

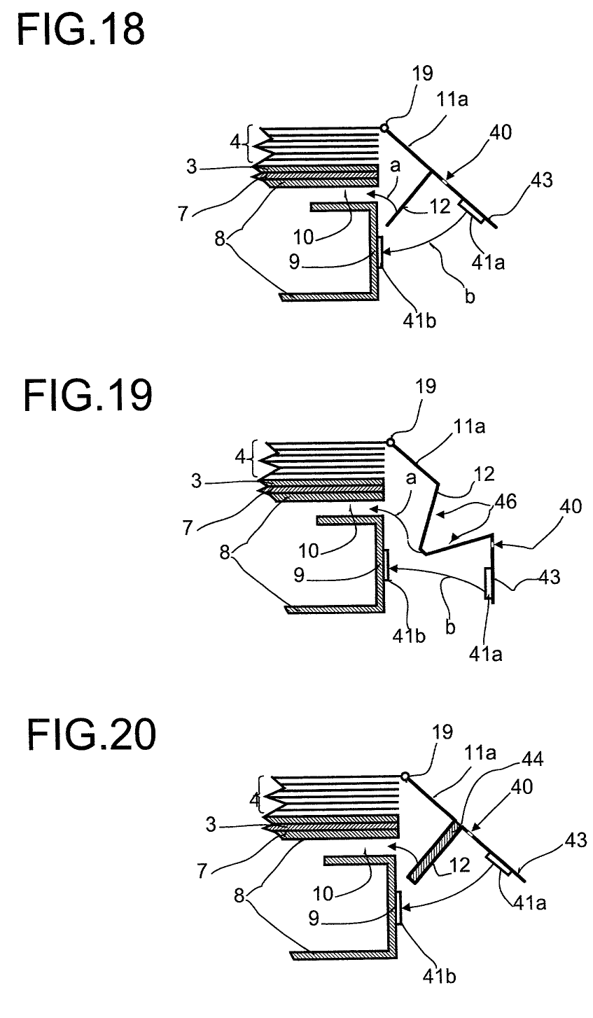

A security device can also be combined with the hold-closed design B, in that—as illustrated in FIG. 18—on the hold-closed extension (11a) fitted to the upper information carrier (4), a branch is made to form the insertion end (12) and a securing end (43). The base element (3) is connected to the outer (8) of the package by the adhesive layer (7). Located between the outer (8) and the closure flap (9) of the package is the gap opening (10), into which the insertion end (12) can be inserted.

The securing end (43) is fixed to the outer of the package and prevents the package being opened. Such a branch can be obtained in a simple way, for example as illustrated schematically in FIG. 19 (not to scale), by a further extension (securing extension) (43) being fitted to the insertion end (12) of the hold-closed means, said further extension being longer than the insertion end (12). When the insertion end (12) is inserted into the slot (10), as indicated by the arrow (a) the securing extension is bent back and also pushed partially into the slot, but projects beyond the slot. That part of the securing extension which projects beyond the slot then forms the securing end (43), which is fixed in a suitable way, for example by means of the permanent adhesive (41a, 41b) to the package, for example on its top flap (9)—as shown by the arrow (b) in FIG. 19—or, if it is longer than illustrated in FIG. 19, to the outer (8) of the package.

Particularly important information, for example instructions for use and the like, which are to be made available to the user in a very striking manner, can be applied to the areas (46) of the insertion end and of the securing extension. As long as the package is closed, the areas (46) rest on one another and the information applied to them is invisible. When the package is opened, the user naturally directs his full attention to the opening manipulation and, when the hold-closed end with the appended securing attachment is pulled out, the aforesaid important information is unexpectedly and surprisingly made visible to him. The surprise effect and the concentration of the attention on the areas (46) which become visible lead to an improved acceptance of information, which in turn helps to optimize the safety in the handling and use, for example of clinical test samples.

If it is not desired to use the areas (46) in the manner specified to impart information in a particularly striking way, then the insertion end and securing extension can also be adhesively bonded to each other in the area of the double layer—as illustrated by the adhesive layer (44) in FIG. 20.

In the case of this type of securing means, neither the package nor the label can be opened without severing the securing extension.

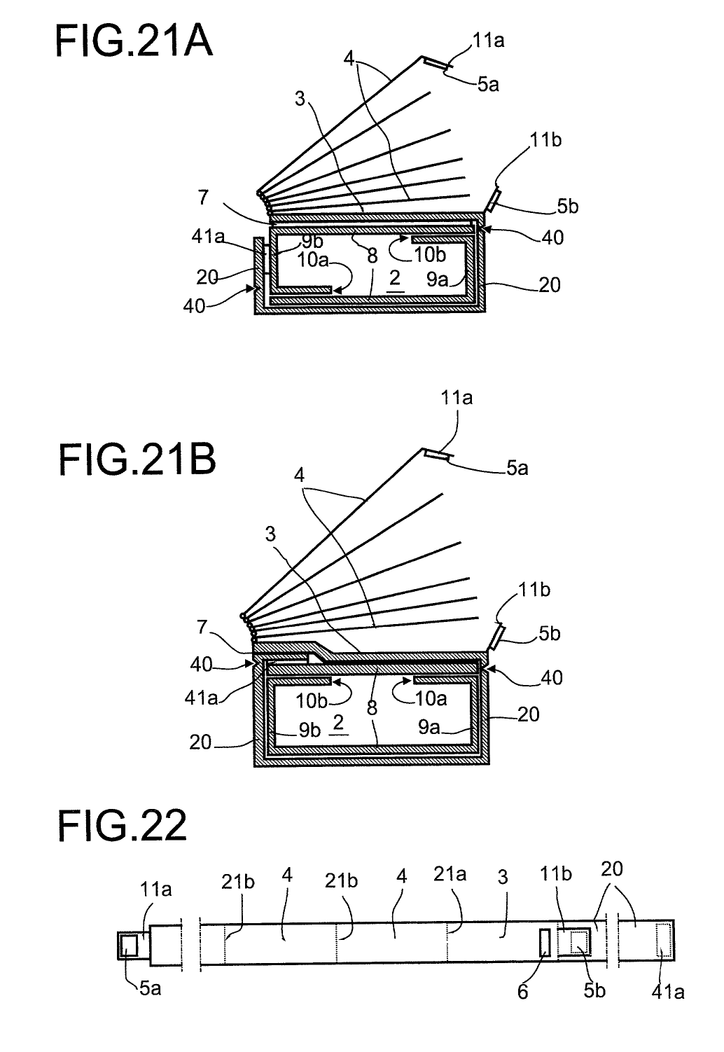

The securing measures illustrated in FIGS. 17a, 17b, 18, 19 and 20 are used to secure a single folding lid (9) of a package (folding box) against unauthorized opening. If a second folding lid (number 9a in FIGS. 21a and 21b) is also to be secured against unauthorized opening, then it can either be adhesively bonded within the package in such a way that it cannot be opened without damaging the package, or, as illustrated in FIG. 16, the package can be protected by two base overhangs which cover the entire package in the manner of a wrapper, or the length of a base overhang or of the securing extension of the label according to the invention has to be dimensioned in such a way that it can also cover the second opening gap (number 10a in FIGS. 21a and 21b) and can be fixed to the package on the other side of said opening gap, for example to the second folding lid, as illustrated schematically and not to scale in FIG. 21a, or can be fixed to the outer of the package underneath the base element, as shown in FIG. 21b.

The various above-described design features, such as the various embodiments of the hold-closed means, the adhesive elements and securing devices, can be combined with one another in many and various ways as appears expedient in the individual case. Combinations of this type, which appear to be possible on the basis of the above description of the configuration and the functioning of the relevant design elements, are likewise the subject of this invention. In addition, the sizes and shapes of the deign elements, for example of the hold-closed elements, securing extensions, base-element overhangs, which are illustrated in the figures and the corresponding sections of the description are to be understood as examples serving the purpose of illustration and, within the context of the present invention, can be varied as long as they exercise the function assigned to them.

Multipart labels according to the invention which have a plurality of the abovementioned preferred features are particularly preferred.

The present invention also relates to a method of producing the multipart label according to the invention. Production is expediently carried out in such a way that a base element and information carriers are cut to size from one of the aforementioned materials, it being possible for the materials for base element and information carrier to be the same or different. When the base elements are being cut to size, overhangs and/or hold-closed extensions which may be desired the same time and/or securing extensions, are expediently also cut out at the same time as the information carriers are cut to size. Of course, it is also possible to fit these extensions subsequently to the base element and information carriers. Smaller areas for fastening the individual elements to one another (fastening areas), larger areas for accommodating the information (information areas) are provided on the blanks and, if necessary, prepared for these functions, for example by the application of adhesive in the fastening area and/or the production of suitable and/or adhesively bondable surfaces in the information areas to accommodate information, for example by means of printing, embossing, stamping, burning-in, magnetization or optoelectronic writing, preferably for printing. Between the information and fastening areas of the information carriers, if required—that is to say if the flexibility inherent to the information-carrier material is not adequate for the pages of the label to be turned—flexible bending points functioning like hinges are inserted by means of the abovementioned known measures, such as specific changes to the material structure, scoring or perforation, and the information carriers and base elements are then fastened to one another at the fastening areas by means of the abovementioned known mechanical or adhesive fastening means. During the production of the variant A of the label according to the invention, the hold-closed extensions are provided with the abovedescribed, preferably mechanically or adhesively interacting, adhesive means, and during the production of the variant B, a bending line can be provided transversely with respect to the longitudinal axis of the hold-closed extension, said bending line coming to lie over the slot (10) in the package to be labeled when the label is closed. In this case, the total length of the hold-closed extension is preferably dimensioned such that it can be inserted into the slot in the package while being bent only slightly.

Exposed adhesive layers of the label are expediently covered and protected by pull-off films. The information can be applied to the information area in a production stage which best suits the operational conditions. If desired, the labels can also be supplied without information to users who wish to apply the information themselves. The sequence of these production measures can also be adapted as far as possible to operational requirements.

In an alternative, preferred production method, the base element and the information carriers are cutout of a coherent strip of a suitable flat material of adequate strength. Hold-closed extensions and/or securing extensions and/or overhangs can be cutout of the two ends of the strip at the same time or, as explained in more detail below, can be cutout in the form of tongue-like flat elements from the base-element area or information carriers. However, they can also be fitted subsequently.

The width of the strip essentially corresponds to the width of the package, and the length is expediently a whole even multiple of the length of the package and, if desired, a length allowance as large as the package thickness. FIGS. 7a, 7b and 7c illustrate such a strip and the treatment of the strip described in the following text. At the end of the base element, the strip is flexibilized, at a line transverse to the longitudinal direction—depicted in FIGS. 7a, 7b and 7c by the dashed line (21a)—by means of suitable measures, so that it can be folded against the base element at this line. There is then a flexible transverse line (dashed lines 21b) in each case at the spacing of the pack length, so that a multiplicity of information-carrier areas are produced.

If zigzag folding of the information-carrier stack according to FIG. 6 is provided, the hold-closed elements 11′a and 11′b can be obtained from the areas of the uppermost or second uppermost and of the lowest information carrier in the stack, as has been illustrated in FIG. 7b. Starting from a point on or close to a bending line (21a) or (21b), a cut of appropriate size is guided in the area of the information carrier along the circumference of an area element (11′b) or (11′a), and ends at a point spaced apart from the starting point on or in the vicinity of the aforesaid bending line. In FIG. 7b, this cut is illustrated by the continuous lines bounding the area elements 11′a and 11′b. This measure produces material tongues which can be folded out of the area of the information carrier. These tongues form the hold-closed extensions 11′a and 11′b which are subsequently provided with congruent, cooperating adhesive elements 5′a and 5′b. This method of producing hold-closed extensions from other components of the labels according to the invention is also illustrated, for example, in FIG. 17, where a tongue-like hold-closed extension (11b) is produced from an overhang (20) in a similar way. It goes without saying that the tongue-like hold-closed extension 11′b can also be formed from the base element in a similar way and that the tongue-like hold-closed extensions can also be produced separately and can be fastened, for example adhesively bonded, to the undamaged information carriers or the base element.

If a spacing (22) of the magnitude of the pack thickness is desired between the base element and the information-carrier stack, as shown in FIG. 7c, the strip is first of all flexibilized transversely to its length at this spacing from the end of the base element, at (21c), and this is then followed by the above-described flexible transverse lines (21b).

The information-carrier areas can then be put together in a zigzag fold to form an information-carrier stack, the embodiment of FIG. 6 being obtained, or, if necessary, two successive information-carrier sections can also be adhesively bonded together by their mutually facing areas, the embodiment of FIG. 5 being obtained.

The alternative production method described can also be used for the production of multipart labels according to the invention which, at the same time, ensure that the package is secured against unauthorized opening in that, as illustrated in FIG. 21a and 21b, a base overhang or a securing extension reaches over one or more folding-lid gaps (10a, 10b) of the package to be labeled and protected, and are permanently fixed to a point on a folding lid or the outer of the package at a point on the other side of said package. An embodiment of the label according to the invention of this type which is suitable for securing the package is obtained by the alternative production method if, according to FIG. 22, a base overlap (20) is applied to that end of the material strip which is not connected to the information carriers, expediently being cut at the same time, and its length is dimensioned such that it reaches over the gap openings (10a, 10b . . . ) of all the opening flaps present in the package and can be fixed on the other side of the same—as illustrated in FIGS. 21a, 21b. If a hold-closed means 11b is desired, a tongue-like area of that type is expediently cut out of the base overhang (20) in such a way that it still remains connected to the base element by its baseline. If bent up and interacting with the extension 11a, it can effect the action of holding the label closed, while the base overhang (20) at its end provided with the permanent adhesive 41a can be used to secure the folding lid of the package against unauthorized opening.

One variant of this production method is that one area of the package to be labeled is itself used as the base element and is prepared for this function.

The invention further relates to the use of the multipart label according to the invention for identifying primary and secondary packing material.

The following exemplary embodiments illustrate the production of multipart labels according to the invention is not restricted to the embodiments illustrated.

### EXAMPLE 1

For a pack having a labeling area of 8×5 cm, a suitable label according to the invention of design A is produced as follows:

a) Production of a base element

A rectangular section of size 9×5 cm is cut out of a heat-bonded polyester fiber nonwoven with a weight per unit area of 120 g/m2. On its upper side, a portion of the area of 8.2 cm, calculated from the right-hand margin, is provided with a paper coating containing titanium dioxide, and on the underside, a strip 1 cm wide, measured from the right-hand margin, is provided with a silicone resin coating.

The marginal strip of 0.7 cm width remaining exposed on the left constitutes the fastening area of the base element, and the 1 cm wide right-hand margin is used as a hold-closed extension (11b).

Then, essential basic information about the pack content for which the label is provided is printed onto the information area provided with the paper coating, a label number which is to be repeated on the package to be labeled is printed in a reserved portion of the area along the short edge.

b) Production of the information carriers

9 rectangular sections of a size 8×5 cm, and a section of a size 8×6 cm are cut out of a heat-bonded polyester fiber nonwoven with a weight per unit area of 80 g/m2. On the upper and lower sides of the 9 identical blanks, a portion of the area of 7.3 cm, calculated from the right-hand margin, is provided with a paper coating containing titanium dioxide. The marginal strip of 0.7 cm width which remains free constitutes the fastening area of the information carriers. On the longer blank, a portion of the area of 1 cm to 8.3 cm, measured from the right-hand margin, is provided with a paper coating containing titanium dioxide, and on the underside a strip of 0.8 cm, measured from the right-hand margin, is coated with a contact adhesive. This part of the blank is used as a hold-closed extension (11a).

After that, index strips are cut off of each of the information carriers so as to correspond to its envisaged position in the stack.

The information carriers prepared in this way are provided in order with the information intended for them. The index strips are provided with the keyword codes, for example the country codes. The uppermost information carrier is given on the upper side the same essential basic information which has also been printed on the information area of the base element, and, here, too, a label number which is to be repeated on the package to be labeled is printed in a reserved portion of the area along the short edge.

The information carriers are then stacked flush over the base element in the envisaged sequence, and the entire stack consisting of the 10 information carriers and the base element is stapled by a stapling machine by means of a wire staple. The hold-closed extensions are bent toward each other, so that the adhesive layer of the extension (11a) comes to lie on the silicone layer of the extension (11b).

### EXAMPLE 2

For a pack with a labeling area of 8×5 cm, a suitable label according to the invention of design A is produced as follows:

a) Production of a base element

A rectangular section of a size 9×5 cm is cut out of a heat-bonded polyester fiber nonwoven having a weight per unit area of 120 g/m2. On its upper side, a portion of the area of 8.2 cm, calculated from the right-hand margin, is provided with a paper coating containing titanium dioxide. After drying, a contact adhesive coating is applied to the remaining portion of the area of 0.7 cm, measured from the left-hand margin, of the upper side and to the entire underside with the exception of a 1 cm wide strip, measured from the right-hand margin, and after evaporation, said contact-adhesive coating is covered by a suitable PTFE-impregnated protective film that can be pulled off. The 1 cm wide adhesive-free marginal strip is provided on the underside with a silicone resin coating; it is used as the hold-closed extension (11b).

Then, essential basic information about the pack content for which the label is provided is printed onto the information area provided with the paper coating, and a label number which is repeated on the package to be labeled is printed in a reserved portion of the area along the short edge.

b) Production of the information carriers

9 rectangular sections of a size 8×5 cm and a section of a size 8×6 cm are cut out of a heat-bonded polyester fiber nonwoven having a weight per unit area of 80 g/m2. On the upper and lower sides of the 9 identical blanks, a portion of the area of 7.3 cm, calculated from the right-hand margin, is provided with a paper coating containing titanium dioxide and, after drying, a contact adhesive is applied to both sides of the blanks in a portion of the area of 0.7 cm, calculated from the left-hand margin, and, following evaporation, is covered with a protective film that can be pulled off.

On the longer blank, a portion of the area of 1 cm to 8.3 cm, measured from the right-hand margin, is provided with a paper coating containing titanium dioxide. After drying, a contact adhesive is applied to both sides of the blank in a portion of the area of 0.7 cm, calculated from the left-hand margin, and, after evaporation, is covered by a protective film that can be pulled off. On the underside of the blank, a strip of 0.8 cm, measured from the right-hand margin, is coated with a contact adhesive. This part of the blank is used as the hold-closed extension (11a).

The left-hand, adhesive-coated marginal strip of 0.7 cm width represents the fastening area of the information carriers.

After that, register strips are cut out of each of the information carriers, corresponding to its envisaged position in the stack.

The information carriers prepared in this way are provided in order with the information intended for them. The index strips are provided with the keyword codes, for example the country codes. The uppermost information carrier is given, on the upper side, the same essential base information which has been printed on the information area of the base element, and here, too, a label number that repeats on the package to be labeled is printed on in a reserved portion of the area along the short edge.

After that, the information carriers are stacked flush over the base element in the envisaged sequence and firmly clamped in position. The protective films are then removed one after another from the fastening area of the base element and from the fastening areas of the information carriers and bonded to the adjacent adhesive areas by means of a short, powerful pressure. The hold-closed extensions are bent toward each other, so that the adhesive layer of the extension (11a) comes to lie on the silicone layer of the extension (11b).

### EXAMPLE 3

For a pack with a labeling area of 8×5 cm, a suitable label according to the invention of design B is produced as follows:

a) Production of a base element with overhang

A rectangular section of a size 8.6×5 cm is cut out of a heat-bonded polyester fiber nonwoven with a weight per unit area of 120 g/m2. On its upper side, a portion of the area of 8.0 cm, calculated from the right-hand margin, is provided with a paper coating containing titanium dioxide. After drying, a contact adhesive coating is applied to the underside over an area of 8 cm, measured from the right-hand margin, and, after evaporation, is covered with a suitable PTFE-impregnated protective film that can be pulled off.

Then, essential basic information about the pack content for which the label is provided is printed onto the information area provided with the paper coating, and a label number that is repeated on the package to be labeled is printed on in a reserved portion of the area along the short edge.

b) Production of the information carriers

6 rectangular sections of a size 16×5 cm are cut out of a heat-bonded polyester fiber nonwoven with a weight per unit area of 80 g/m2. On the upper and lower sides, portions of the area of 7.8 cm, calculated from the right-hand and left-hand margin, are provided with a paper coating containing titanium dioxide. In this way, information-carrier strips are obtained which, apart from a zone of 0.4 cm width located at the center, are coated on both sides with the paper coating. After drying, the strips are folded at the center, where no paper coating has been applied. After that, index strips are cut out of each of the information carriers, corresponding to its envisaged position in the stack.

The information carriers prepared in this way are provided in order with the information intended for them. The index strips are provided with the keyword codes, for example the country codes. The uppermost information carrier is given, on the upper side, the same essential basic information which has also been printed on the information area of the base element, and here, too, a label number that is repeated on the package to be labeled is printed on in a reserved portion of the area along the short edge.

The information-carrier strips 1 to 3 are laid one above another, folded jointly in the center (free of paper coating) and sewn into the fold onto the overhang area of the base element produced under a). The same procedure is followed with the strips 4 to 6. Then, the bundle of strips connected to the overhang of the base element is folded to the right, and the information-carrier stack is formed in this way. A 3 cm long and 2 cm wide strip-like hold-closed extension (11a) with an insertion end (12) is adhesively bonded onto the uppermost information carrier in such a way that the hold-closed extension and the insertion end form a 2 cm long tongue located on the center line of the information carrier.

The label produced in this way is used for labeling a folding box which is provided with a security wrapper which has a window opening 2.2 cm wide in the area of the slot (10).

### EXAMPLE 4

For a package having a front area to be labeled of 6.5×5.5 cm and a depth of 1.0 cm, a suitable multipart label according to the invention of design B is produced as follows:

a rectangular strip of a size 79.1×5.5 cm is cut out of a heat-bonded polyester fiber nonwoven having a weight per unit area of 100 g/m2, said strip having at the end a tongue 3 cm long and 2 cm wide. On its upper side, the strip is provided with a paper coating containing titanium dioxide. After drying, a contact-adhesive coating is applied to the underside, the end field of the strip, 6.5 cm long, provided with the cut-out tongue being left free and, after evaporation, being covered with a suitable PTFE-impregnated protective film that can be pulled off.

The protective film that covers the contact adhesive is then slit at a distance of 6.5 cm, 7.6 cm and then in each case after a further 6.5 cm. Beginning with the first adhesive-coated section of the strip, adjacent to the end strip, the protective films are then pulled off two each of the 6.5 cm long sections, and the sections are bent together such that the adhesive fields come to lie one above another with an exact fit, and are then united with each other by brief pressure. This procedure is continued until 10 of the areas have been unified to form 5 double areas. What remains is then the 6.5 cm long end section provided with the tongue, and a 1.1 cm long field of the strip and the 6.5 cm long starting field of the strip.

The starting field is used as the base element for fastening the label to the front side of the package, and the 1.1 cm long field is used to place the information carriers on the rear of the package, and the free end field serves as the uppermost information carrier provided with the hold-closed extension (11a) and insertion end (12).

Information can be applied to the free sides of the information carriers either after the above-described production of the label, for example by sticking on marked self-adhesive labels, or said information can be printed on at any desired time after the paper coating has dried.

Meaning of the Reference Numbers in the Figures

1 Label according to the invention

2 Package

3 Base element

4 Information carrier

5a,5b,5′a,5′b Adhesive elements, for example adhesive and smooth layer or surface fastener elements

6 Field for essential data, for example label number

7 Adhesive layer

8 Outer of the package

9,9a,9b Closure flap

10,10a,10b Gap/slot opening on the closure flap of the package

11a,11b,11′a, Hold-closed extensions for information carrier (a) and

11′b base element (b)

12 Insertion end of the hold-closed extension (11a, 11′a)

13 Trapezoidal folding-box elements

14,14′ Information area of the base element

15 Fastening area of the base element

16,16′ Information area of the information carrier

17 Fastening area of the information carrier

18 Staple

19 Flexibilized zones present if necessary

20,20a Overhang

21a,21b,21c Flexibilized bending lines

22 Spacing corresponding to the package thickness

23 Frame for hold-closed extension

24 Adhesive layer

25 Cut in the hold-closed extension

26 Elastically bent insertion end of the hold-closed extension

27 Stick-on label

28 Index

29 Subarea of the base element for variable data

30 Window openings in the information carriers

31 Field for explanations relating to the data in field 29

32a Notch from the upper side

32b Notch from the underside

33 Three-layer information carrier

34 Information-bearing layer

35 Adhesive-repelling layer

36 Exposed adhesive area

37a,37b Information-carrier stack

38 Overlap area

39 Joining means

40 Intended fracture lines

41a,41b Fastening means

42 Window opening in overhang

43 Securing extension

44 Adhesive layer

45 Grip tab

46 Information areas

We claim:

1. A multipart label (1) for applying information, in particular information relating to the content, to primary or secondary packages (2) with a marking area which is enlarged with respect to the package areas, comprising a flat base element (3), which is suitable for fixing the label securely to the package to be labeled, or which is itself part of the package, one or more flat information carriers (4), which are fastened (hinged) to the base element (3) such that they can be folded, and a hold-closed means which can be activated and deactivated, comprising either
A) contact-adhesive elements which act between the uppermost or one of the upper information carriers and the base element or the lowest or one of the lower information carriers and can be applied directly to the components of the label which are to be connected or to extensions (hold-closed extensions), or
B) an extension to the uppermost or one of the upper information carriers which, after the label has been fixed to the package, can interact with a functional constructional feature which is necessarily present in the package and, in the active state, prevent those parts of the label which are enclosed by the closure device from folding out unintentionally.

2. A multipart label as claimed in claim 1, wherein the base element projects beyond the package area to which it is to be fixed, forming one or more overhanging areas.

3. A multipart label as claimed in claim 1, wherein the first, lowest information carrier is fastened (hinged) directly to the base element or to an overhang of the base element, each further information carrier located above is then fastened (hinged) to the previous one, either the higher information carriers in each case being hinged to that edge of the information carrier located beneath it by which it is fastened to its predecessor or to the base element, or the higher information carriers in each case being hinged to the free edge of the predecessor.

4. A multipart label as claimed in claim 1, wherein the base element is part of the package.

5. A multipart label as claimed in claim 1, wherein an overhang covers the slot opening (10) or the slot openings (10a, 10b) on the closure flap (9) or the closure flaps (9a, 9b) of the package, and its free end is fixed on that side of the slot opening(s) and/or wherein the overhang covering the slot opening(s) (10, 10a, 10b) is fixed on the closure flap or the outer part of the package or on the opposite side of the base element or, with an overhang which is present there, jointly encloses the package, and their free ends are fixed to each other, by which means the package is enclosed and secured in the manner of a security wrapper.

6. A flat information carrier for labeling packages, from which one or more subareas which bear information can be separated, which are located at any desired locations on the information carrier and can have any desired shapes, wherein the information carrier is configured with at least three layers, the lower layer being an adhesive-repelling layer, for example a silicone paper layer, adjacent to this an adhesive layer and, above the latter, at least one adhesive accepting layer bearing the information, and wherein the portion to be separated from the information carrier is prepared, by means of a purposeful double notch along at least one boundary line, in such a way that when it is separated from the information carrier along this boundary line, a free strip of adhesive remains on the separated section.

7. An information carrier as claimed in claim 6, wherein it is an information carrier belonging to the multipart label of claim 1.

8. A method of producing the multipart label of claim 1, wherein a base element and information carriers are cut out of a suitable flat material of sufficient strength, it being possible, during the cutting of the base elements, for any desired overhangs and/or hold-closed and/or security extensions to be cut at the same time as the cutting of the information carriers, for smaller areas for the fastening of the individual elements to one another (fastening areas), larger areas to accommodate the information (information areas) to be provided on the blanks, and, if necessary, prepared for these functions, if necessary, flexible bending points functioning like hinges being inserted between the information and fastening areas of the information carriers, and subsequently the information carriers and base elements being fastened to one another at the fastening areas.

9. A method of producing the multipart label of claim 1, wherein the base element and the information carriers are cut out of a coherent strip of a suitable flat material of sufficient strength, it being possible for hold-closed and/or security extensions and/or overhangs with cut or tongue-like extensions to be cut out, the width of the strip essentially corresponding to the width of the package, the length of a whole even multiple of the length of the package and, if desired, a length allowance of the size of the pack thickness, then, in each case at intervals of the packaging length, a flexible transverse line being produced, so that a base element and a large number of information-carrier areas are produced or, if an interval of the size of the pack thickness is desired between the base element and the information-carrier stack, the strip is firstly flexibilized, transversely with respect to its length, at this interval from the end of the first section (base element) and, after that, the further flexible transverse lines are produced at intervals of the packaging length, then the information-carrier areas are put together with zigzag folds to form an information-carrier stack and, if desired, in each case two successive information-carrier sections, beginning with the second and third section, are bonded to the mutually facing areas.

10. A method as claimed in claims 8 or 9, respectively, wherein, during the production of the variant A of the label according to the invention, the hold-closed extensions are provided with adhesive means, which interact preferably mechanically or adhesively, during the production of the variant B, a bending line is provided transversely with respect to the longitudinal axis of the hold-closed extension, by means of which line an insertion end is produced, the total length of the hold-closed extension preferably being such that it can be inserted into a slot opening (10, 10a, 10b) in the package whilst being bent only slightly.

11. A method as claimed in claims 8 or 9, respectively, wherein securing extensions and/or base elements serving as securing extensions are dimensioned such that they cover the slot openings (10, 10a, 10b) of all the opening flaps present on the package and can be fixed on the other side of the latter.

12. A method of using the multipart label of claim 1 for identifying primary and secondary packaging materials.
